(19) United States
(12) Patent Application Publication
(10) Pub. No.: US 2016/0293167 A1
(43) Pub. Date: Oct. 6, 2016

(54) SPEAKER RECOGNITION USING NEURAL NETWORKS

(71) Applicant: Google Inc., Mountain View, CA (US)

(72) Inventors: Yu-hsin Joyce Chen, Mountain View, CA (US); Ignacio Lopez Moreno, New York, NY (US); Tara N. Sainath, Jersey City, NJ (US); Maria Carolina Parada San Martin, Palo Alto, CA (US)

(21) Appl. No.: 15/179,717

(22) Filed: Jun. 10, 2016

Related U.S. Application Data
(63) Continuation-in-part of application No. 14/224,469, filed on Mar. 25, 2014, now abandoned.
(60) Provisional application No. 62/174,799, filed on Jun. 12, 2015.
(60) Provisional application No. 61/889,359, filed on Oct. 10, 2013.

(51) Int. Cl. G10L 17/18; G10L 17/22; G10L 17/08

(52) U.S. Cl. CPC G10L 17/18; G10L 17/08; G10L 17/22

(57) ABSTRACT

Methods, systems, and apparatus, including computer programs encoded on a computer storage medium, for performing speaker verification. In one aspect, a method includes accessing a neural network having an input layer that provides inputs to a first hidden layer whose nodes are respectively connected to only a proper subset of the inputs from the input layer. Speech data that corresponds to a particular utterance may be provided as input to the input layer of the neural network. A representation of activations that occur in response to the speech data at a particular layer of the neural network that was configured as a hidden layer during training of the neural network may be generated. A determination of whether the particular utterance was likely spoken by a particular speaker may be made based at least on the generated representation. An indication of whether the particular utterance was likely spoken by the particular speaker may be provided.

### CROSS-REFERENCE TO RELATED APPLICATIONS

This application claims priority to U.S. Provisional Patent Application Ser. No. 62/174,799, filed on Jun. 12, 2015. This application is also a continuation-in-part of U.S. patent application Ser. No. 14/228,469, filed Mar. 28, 2014, which claims priority to U.S. Provisional Patent Application Ser. No. 61/899,359, filed Nov. 4, 2013. Each of application Ser. No. 14/228,469, 61/899,359, and 62/174,799 are incorporated by reference herein in their entirety.

### TECHNICAL FIELD

This specification generally relates to speaker recognition.

### BACKGROUND

Speaker verification may include the process of verifying, based on a speaker's known utterances, whether an utterance belongs to the speaker. Speaker verification systems may be useful in various applications, such as translation and authentication.

### SUMMARY

This document describes various techniques for performing speaker recognition. In some implementations, deep locally-connected networks (“LCN”) and deep convolutional neural networks (“CNN”) are used for text-dependent speaker recognition. These topologies model the local time-frequency correlations of the speech signal using only a fraction of the number of parameters of a fully-connected deep neural network (“DNN”) used in previous works. The techniques discussed below demonstrate that both a LCN and CNN can reduce the total model footprint, for example, to 30% of the original size compared to a baseline fully-connected DNN, generally with reduced latency and minimal impact in performance. In addition, when matching parameters, the LCN can improve speaker verification performance, as measured by equal error rate (“EER”), for example, by 8% relative over the baseline without increasing model size or computation. Similarly, a CNN may improve EER by, for example, 10% relative over the baseline for the same model size but with increased computation.

In one general aspect, a computer-implemented method is performed by one or more data processing devices. The method may include the actions of: accessing a neural network having an input layer and one or more hidden layers, wherein at least one hidden layer of the one or more hidden layers has nodes that are respectively connected to only a proper subset of the inputs from a previous layer that provides input to the at least one hidden layer; inputting, to the input layer of the neural network, speech data that corresponds to a particular utterance; generating a representation of activations that occur, in response to inputting the speech data that corresponds to the particular utterance to the input layer, at a particular layer of the neural network that was configured as a hidden layer during training of the neural network; determining, based at least on the generated representation, whether the particular utterance was likely spoken by a particular speaker; and providing an indication of whether the particular utterance was likely spoken by the particular speaker.

In another general aspect, a method may include the actions of: accessing a neural network having an input layer that provides inputs to a first hidden layer, wherein nodes of the first hidden layer are respectively connected to only a proper subset of the inputs from the input layer; inputting, to the input layer of the neural network, speech data that corresponds to a particular utterance; generating a representation of activations that occur, in response to inputting the speech data that corresponds to the particular utterance to the input layer, at a particular layer of the neural network that was configured as a hidden layer during training of the neural network; determining, based at least on the generated representation, whether the particular utterance was likely spoken by a particular speaker; and providing an indication of whether the particular utterance was likely spoken by the particular speaker.

Aspects of these techniques include methods, systems, apparatus, and computer programs, configured to perform the actions of the methods, encoded on computer storage devices. A system of one or more computers can be configured by virtue of software, firmware, hardware, or a combination of them installed on the system that in operation cause the system to perform the actions. One or more computer programs can be so configured by virtue of having instructions that, when executed by data processing apparatus, cause the apparatus to perform the actions.

These other versions may each optionally include one or more of the following features. In some implementations, the first hidden layer may be a locally-connected layer configured such that nodes at the first hidden layer respectively receive input from different subsets of data from the input layer.

In some examples, the speech data provided to the input layer of the neural network is a set of feature values extracted from audio. For example, the speech data may be one or more vectors of feature values, e.g., values of mel filterbank components, that reflect certain speech characteristics, instead of raw audio data.

In some examples, each of the nodes at the first hidden layer may receive input from a localized region of the inputs from the input layer. In addition, each node may, in some of such examples, be connected to a proper subset of the inputs that is localized in time. In these examples, each node may, in some instances, be connected to a proper subset of the inputs that is localized in frequency.

In some implementations, each node may be connected to a respective subset of the inputs that is localized in time and in frequency. In such implementations, the inputs provided by the input layer may, in some examples, indicate characteristics of the utterance at a first range of frequencies during each time frame in a first range of time. For each of at least some of the nodes of the first hidden layer, the node, in these examples, may only be connected to inputs from the input layer that indicate characteristics of the utterance for a second range of frequencies during each time frame in a second range of time, the second range of frequencies may be a proper subset of the first range of frequencies, and the second range of time may be a proper subset of the first range of time.

In some examples, the input layer may provide a number of inputs to the first hidden layer. For each of the nodes of the first hidden layer, the neural network may, in such examples, include a number of stored weight values that is less than the number of inputs to the first hidden layer.

In some implementations, the first hidden layer may be a convolutional layer. In some of such implementations, at least a group of the nodes of the first hidden layer may be associated with a same set of weight values, and the neural network may apply the same set of weight values to different subsets of the input for different nodes in the group.

In some examples, the actions may further include comparing the generated representation with a reference representation of activations occurring at the particular layer of the neural network in response to speech data that corresponds to a past utterance of the particular speaker. In these examples, determining whether the particular utterance was likely spoken by the particular speaker based at least on the generated representation may include, based on comparing the generated representation and the reference representation, determining whether the particular utterance was likely spoken by the particular speaker.

In some implementations, determining whether the particular utterance was likely spoken by the particular speaker based at least on the generated representation may include determining a cosine distance between the generated representation and a reference representation corresponding to the particular speaker, determining that the cosine distance satisfies a threshold, and based on determining that the cosine distance satisfies the threshold, determining that the particular utterance was likely spoken by the particular speaker.

In some examples, the actions may further include dividing the speech data corresponding to the particular utterance into frames. This strategy is sometimes called “windowing” the signal. The system can apply the same processing to each window of the windowed signal, and can average the results for the various windows. In these implementations, generating the representation of activations occurring at the particular layer of the neural network may, for instance, include determining, for each of multiple different frames of the speech data, a corresponding set of activations occurring at the particular layer of the neural network, and generating the representation of the activations occurring at the particular layer by averaging the sets of activations that respectively correspond to the multiple different frames.

In some implementations, accessing the neural network may include accessing a trained neural network that is not trained using speech of the particular speaker.

In some examples, accessing the neural network may include accessing a neural network having nodes at the first hidden layer that are each connected to a different subset of the inputs from the input layer, wherein the neural network has been trained based on activations occurring at an output layer located downstream from the particular layer. For example, training of a neural network may proceed using propagation and/or backpropagation through the output layer, while speaker models or speaker vectors may be generated without using the output layer that was used during training.

In some implementations, accessing the neural network may include accessing, by a user device, a neural network stored at the user device.

In some examples, the actions may further include detecting the particular utterance at a mobile device that stores the neural network. In such examples, determining whether the particular utterance was likely spoken by the particular speaker may include determining that the particular utterance was likely spoken by the particular speaker, and of whether the particular utterance was likely spoken by the particular speaker may include unlocking or waking up the mobile device in response to determining that the particular utterance was likely spoken by the particular speaker.

In some implementations, each node of the first hidden layer may be connected to between 5% and 50% of the inputs from the input layer.

The details of one or more implementations of the subject matter described in this specification are set forth in the accompanying drawings and the description below. Other potential features, aspects, and advantages of the subject matter will become apparent from the description, the drawings, and the claims.

Other implementations of these aspects include corresponding systems, apparatus and computer programs, configured to perform the actions of the methods, encoded on computer storage devices.

### BRIEF DESCRIPTION OF THE DRAWINGS

FIG. 1A is a diagram that illustrates an example system for speaker recognition using neural networks.

FIG. 1B illustrates an example of a topology of a baseline fully-connected deep neural network and its position in the speaker verification pipeline.

FIG. 2 illustrates examples of weight matrices of first fully-connected layer in DNN which are sparse and well-localized non-zero weights.

FIG. 3 illustrates an example of a comparison of weight matrices of a fully-connected layer and a locally-connected network layer.

FIGS. 4A-B illustrate examples of filters from layers with 12×12 patches.

FIG. 5 is a block diagram of an example system that uses DNN model for speaker verification.

FIG. 6 is a block diagram of an example system that can verify a user's identity using a speaker verification model based on a neural network.

FIG. 7A is a block diagram of an example neural network for training a speaker verification model.

FIG. 7B is a block diagram of an example neural network layer that implements a maxout feature.

FIG. 7C is a block diagram of an example neural network layer that implements a dropout feature.

FIG. 8 is a flow chart illustrating an example process for training a speaker verification model.

FIG. 9 is a block diagram of an example of using a speaker verification model to enroll a new user.

FIG. 10 is a flow chart illustrating an example process for enrolling a new speaker.

FIG. 11 is a block diagram of an example speaker verification model for verifying the identity of an enrolled user.

FIG. 12 is a flow chart illustrating an example process for verifying the identity of an enrolled user using a speaker verification model.

FIG. 13 is a flow chart illustrating an example process for verifying the identity of an enrolled user using a neural network.

FIG. 14 is a schematic diagram that shows an example of a computing device and a mobile computing device.

Like reference numbers and designations in the various drawings indicate like elements.

### DETAILED DESCRIPTION

Speaker recognition may include the process of verifying, based on a speaker's known utterances, whether an utterance belongs to the speaker. When the lexicon of the spoken utterances is constrained to a single word or phrase across all users, the process is referred to as global password text-dependent speaker verification (“TD-speaker verification”). By constraining the lexicon, TD-speaker verification compensates for phonetic variability, which poses a significant challenge in speaker verification. In some examples, a global password TD-speaker verification was targeted.

The techniques described herein may be used to create a small footprint TD-speaker verification system that can run in real-time in space-constrained mobile platforms. Constraints may include that (a) the total number of model parameters must be small, e.g. 0.8M parameters, and (b) the total number of operations must be small, e.g., 1.5M multiplications, in order to keep latency below 40 ms on most platforms. An experimental system for implementing the techniques described herein used a fully-connected Deep Neural Network (“DNN”) to extract a speaker-discriminative feature, or “d-vector”, from each utterance. Utterance d-vectors were incrementally computed frame by frame, and improved latency by avoiding the computational costs associated with the latent variables of a factor analysis model, which occurred after utterance completion.

This disclosure describes various architectures to the fully-connected feed-forward DNN architecture used to compute speaker vectors, with the goal of improving the equal error rate (“EER”) of the speaker verification system while limiting and even reducing the number of parameters and latency. Further, this disclosure discusses architectures which focus on exploiting the local correlations of the speech signal such as locally-connected neural network (“LCN”) and convolutional neural network (“CNN”). Both LCNs and CNNs are based on local receptive fields, i.e. patches, whose characteristic shape is sparse but locally dense. Unlike in other approaches, this techniques described herein use LCNs and CNNs to directly compute speaker discriminative features while simultaneously constraining the size and latency of the model. The findings described in this disclosure demonstrate (i) that LCNs and CNNs may reduce the number of parameters in the first hidden layer by an order of magnitude with minimal performance degradation, and (ii) that for the same number of parameters, LCNs and CNNs can achieve better performance than fully-connected layers. An exemplary global password TD-speaker verification system, in which LCNs are applied over CNNs because LCNs have lower latency, is also proposed and discussed below.

In some implementations, a neural network model for speaker verification is used on a user device, such as a phone, a watch, a tablet computer, a laptop computer, etc. User devices often have limited battery power, storage capacity, and processing capability. Large neural networks can require significant data storage space to store the model, and may require significant amounts of computation to generate speaker vectors for speaker verification. This computation may also cause processing delays that force users to wait while the device responds to an utterance. Using locally-connected layers or convolutional layers in the model can significantly improve the efficiency of and effectiveness of the speaker verification system. The storage space required for a model is decreased, since fewer neural network weights need to be stored than for fully-connected neural networks. Additionally, the amount of computation required when using the model can be decreased significantly, often involving only half as many multiply operations, or less, than a comparable fully-connected model. The reduced amount of computation saves power for battery-operated devices, and also improves speed and responsiveness since less computation needs to be done. When used at a mobile device, e.g., to verify that a hotword or other predetermined phrase was spoken by a particular user, this allow quicker verification with similar performance to a fully-connected network. As another example, using a locally-connected layer or convolutional layer with a similar number of parameters, e.g., neural network weights, as a fully-connected model has been found to increase accuracy and significantly decrease error rates.

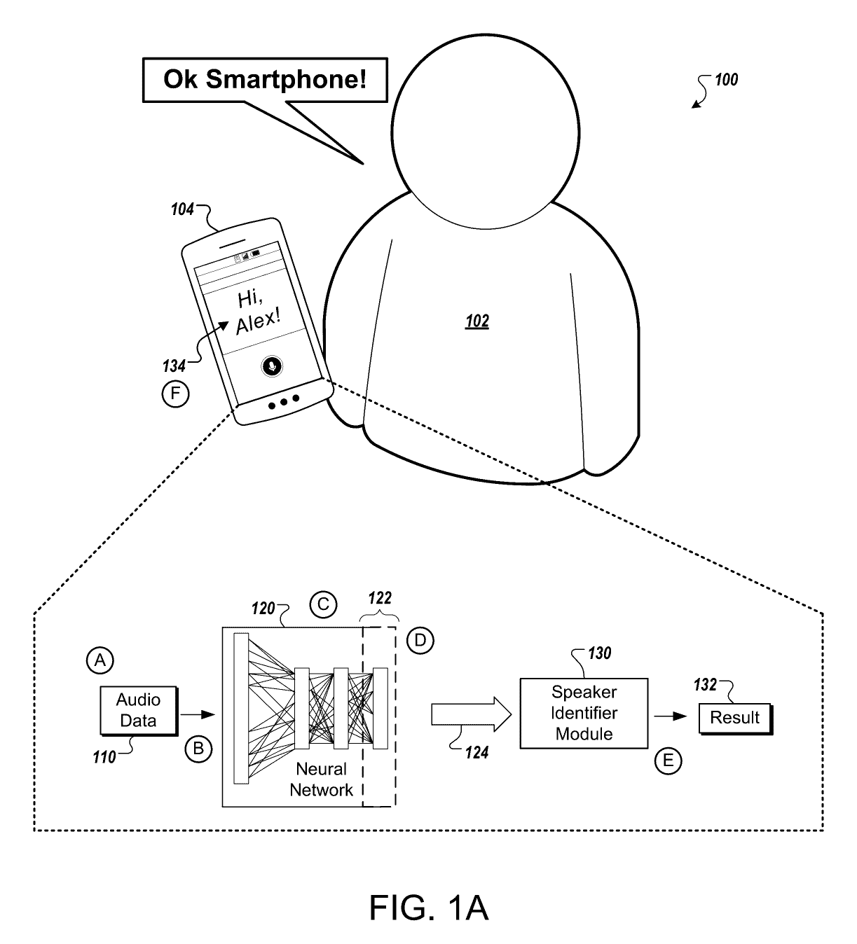

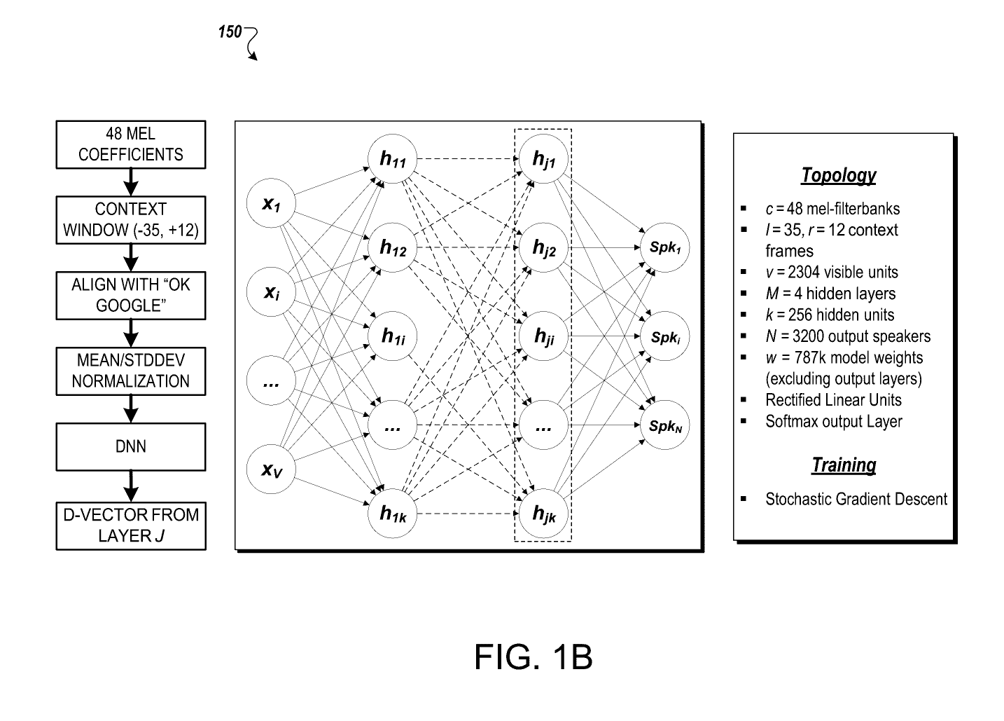

FIG. 1A is a diagram that illustrates an example system 100 for speaker recognition using neural networks. More particularly, the system 100 may include a client device 104. FIG. 1A also illustrates an example flow of data, shown in time-sequenced stages “A” to “F,” respectively. Briefly, and as described in further detail below, the client device 104 may obtain audio data 110 corresponding to an utterance and use neural network 120 to determine that the utterance was likely spoken by user 102. In some implementations, the neural network 120 may be stored and executed on the client device 104. In this way, the client device 104 may perform all or most of the processes to which the example flow of data illustrated in FIG. 1A corresponds.

The client device 104 may, for instance, be a mobile computing device, personal digital assistant, cellular telephone, smart-phone, laptop, desktop, workstation, and other computing device. In this example, the user 102 may be enrolled in a speaker verification service provided by an application running on client device 104 that leverages neural network 120 to determine a given user's identity based on an utterance spoken by the user and perform one or more actions based on the identity determined for the user. For example, the identity of user 102 may be determined based on the utterance, “Ok Smartphone,” as spoken by user 102.

In some implementations, the client device 104 starts in a low-power state, e.g., with the screen off, or in a locked state. The client device 104 can be configured to detect a predetermined hotword or passphrase, in this instance “OK smartphone,” and respond to that hotword or passphrase to wake up and/or unlock the client device 104. This action to wake up or unlock the client device 104 can be conditioned on verification of the speaker's voice, so that the client device 104 only responds when the authorized user 102 speaks the hotword. The hotword can be a signal to the client device 104 that a voice command follows the hotword, and the client device 104 can process speech following the hotword to identify a command and carry out the command. Processing the command may be conditioned on successful speaker verification of the hotword, so that an unauthorized or unknown user is not allowed to enter voice commands.

As user 102 speaks, the client device 104 may, in real-time during stage A, record the user's utterance and generate audio data. The client device may extract information from the raw audio waveform to generate speech features, such as mel-frequency filterbank outputs. The extracted data, e.g., vectors of feature values representing speech characteristics, can be used as audio data 110 for input to a neural network model.

At stage B, the audio data 110 may be provided as input to an input layer of neural network 120. At stage C, nodes at each layer of neural network 120 may be activated in response to inputting audio data 110 to the input layer of neural network 120. The activation of nodes in the input layer of neural network 120 in response to audio data 110 may cause downstream nodes that are directly and indirectly connected to nodes of the input layer to be activated. Some layers of the neural network 120 may be fully connected to each other. For example, if a second layer is fully-connected to a previous first, layer, each node at the first layer may provide output as an input to each node in the second layer. One or more layers of the neural network 120 may not be fully connected however. For example, some or all of the layers may have only partial connections with previous layers, so that certain nodes receive only a subset of the activations at the prior layer. As discussed further below, the partial connections may be implemented as locally-connected network (LCN) layers or convolutional neural network (CNN) layers. In some implementations there may be more than one LCN or CNN layer in the neural network. For example, any given layer “L” may be connected to only a proper subset of the outputs from the previous layer “L-1”. The layer “L-1” may be the initial input layer to the neural network 120, or may be a hidden layer or other layer of the network 120.

In the particular example of FIG. 1A, the nodes of the first hidden layer do not each receive all of the inputs from the input layer. Downstream nodes that are directly connected to the input layer of neural network 120, such as those which belong to the first hidden layer of neural network 120, may be respectively connected to only a proper subset of the nodes in the input layer. More particularly, the first hidden layer of neural network 120 may, in some implementations, be a locally-connected layer or a convolutional layer. That is, the neural network 120 may, in these implementations, represent at least a portion of an LCN or CNN. Neural network 120 may, for instance, have a topology similar to one or more of the exemplary topologies described in association with FIGS. 1B-5 below.

At stage D, a representation 124 of activations 122 occurring at a particular layer of neural network 120 in response to audio data 110 may be generated and provided as input to a speaker identifier module 130. This representation 124, which is also referenced herein as “d-vector,” “speaker vector,” or simply “vector,” can be seen as a speaker-discriminative feature. The particular layer of neural network 120 at which activations 122 occur in response to audio data 110 may, for example, be a layer that was configured as a hidden layer during the training of neural network 120. For example, it can be the set of activations at the second-to-last layer of the network that was adjusted during training, e.g., the layer immediately prior to the output layer used in training. The speaker identifier module 130 may, at stage E, determine whether the utterance that corresponds to audio data 110 was likely spoken by a particular speaker based on the generated representation 124 and provide result 132 as indication of the outcome of the determination. For instance, the result 132 may have indicated that the utterance corresponding to audio data 110 was likely spoken by a user named “Alex,” who previously provided a voice sample during enrollment with the device 104. The speaker identifier module 130 may be configured to verify that a voice input corresponds to a particular, predetermined speaker, or may be used to determine which speaker, from among multiple speaker identities, spoke the utterance.

At stage F, one or more actions may be performed based on the identity determined for user 102. Such actions may be performed in response to speaker identification module 130 having made a determination based on representation 124 and based on the nature of the result 132 that indicates the outcome of the determination. For example, the client device 104 may display a screen 134 that says “Hi Alex” in response to identifying the speaker of the utterance corresponding to audio data 110, or user 102, as “Alex.” It follows that, in the event that the result 132 were to have indicated that audio data 110 was spoken by someone other than user 102 or “Alex,” the client device 104 may, at stage F, not display a screen 134 that says “Hi Alex” and, in some examples, display another, different screen that is tailored for the user identified by the result 132.

Additional examples of such actions may, for instance, include one or more actions of waking client device 104 up from a low power state (e.g., receiving a hotword, where waking up is conditioned on detecting the hotword and a voice match), authenticating user 102 or another verified user of client device 104, logging user 102 or another verified user of client device 104 into a corresponding user account, providing user 102 or another verified user of client device 104 to one or more applications and/or websites, unlocking client device 104, invoking a virtual assistant that causes audible, synthesized speech to be played and/or a virtual assistant user interface to be presented, performing a voice command (e.g., submitting a query, opening an application, playing music, etc.), sending authentication data over a network to one or more other computing devices, applying user preferences or user interface customizations for the verified user of client device 104, and the like.

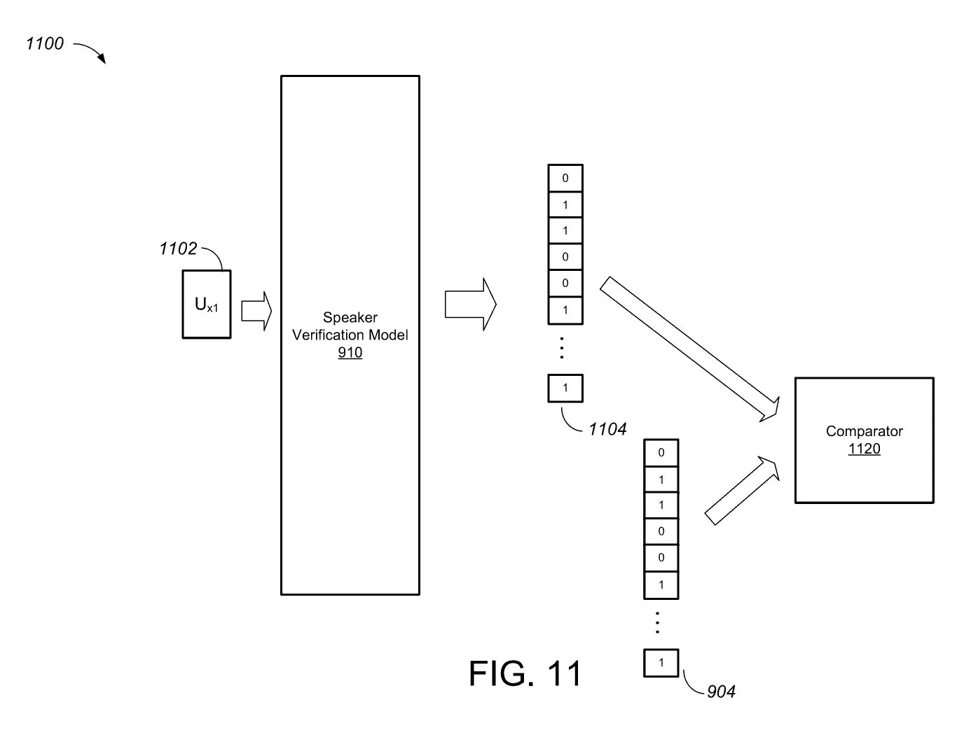

It is to be understood that some or all of these exemplary actions may, in some implementations, only be performed (i) in response to speaker identification module 130 having made a determination based on representation 124 and (ii) based on the result 132 indicating that audio data 110 was likely spoken by a verified user of client device 104. In some of these implementations, other actions, such as those that are logical inverses of some or all of the exemplary actions described above, may be performed (i) in response to speaker identification module 130 having made a determination based on representation 124 and (ii) based on the result 132 indicating that audio data 110 was not likely spoken by a verified user of client device 104. Processes similar to those which have been described in association with FIG. 1 are described in further detail below, in reference to FIG. 11.

FIG. 1B illustrates an exemplary topology 150 of a baseline fully-connected DNN and its position in the speaker verification pipeline. More specifically, FIG. 1B includes a pipeline process from the waveform to the final score (left), DNN topology (middle), and DNN description (right). Let x^{t} be the input features of the input layer at time t. x^{t} is formed by stacking q-dimensional mel-filterbank vectors by l contextual vectors to the left and r contextual vectors to the right; the total number of stacked frames is l+r+1. Therefore, there are v=q(l+r+1) visible units per input x^{t}. The hidden layers contain units with a rectified linear unit (ReLU) activation. Each hidden layer contains k units. The first layer may be replaced with a locally-connected layer or convolutional layer to improve performance, reduce model size, and obtain other benefits as discussed herein.

The output of the DNN may be a softmax layer which corresponds to the number of speakers in the development set, N. Each input may have a target label, which is an integer corresponding to speaker identity. The DNN may be trained using the cross-entropy criterion.

For enrollment of a new speaker identity, the parameters of the DNN may be fixed. D-vector speaker features may be derived from output activations of the last hidden layer, e.g., before the softmax layer. Such D-vector speaker features may be similar to the representation 124 of activations 122 occurring at a particular layer of neural network 120, as described above in reference to FIG. 1A. To compute the d-vector, for every input x^{t} of a given utterance, some techniques may involve computing the output activations h^{t}ⱼ of the last hidden layer j, using standard feed-forward propagation. An element-wise maximum of activations may then be taken to form the compact representation of that utterance, the d-vector \vec{d}. Thus, the i^{th} component of the k-dimensional d-vector \vec{d} is given by:

$${\vec{d}}_{i} = {max}_{t} ( {h}_{ji}^{t} ) \qquad ( 1 )$$

Note that none of the parameters in the output layers are used in the computation of \vec{d}. In some examples, such parameters may be discarded. Thus, for M hidden layers, the number of total weights w in real-time system is given by:

w=vk+(M−1)k² (2)

In this example, each utterance generates exactly one d-vector. For enrollment, a speaker may provide a few utterances of the global password; the d-vector from each of these utterances is averaged together to form a speaker model that is used for speaker verification, similar to the original i-vector model.

During evaluation, the scoring function may be the cosine distance between the speaker model d-vector and the d-vector of an evaluation utterance.

In order for the exemplary speaker verification system to run in real-time on space-constrained platforms, the size of the DNN feature extractor must be small. However, in a fully-connected model with large number of visible units v, the term vₖ dominates over the rest of terms in Eq. 2; the first hidden layer accounts for most of the parameters. For example, the baseline model may be a fully-connected DNN model with v=48×48 input elements and k=256 hidden nodes in each of M=4 hidden layers, such that the input layer accounts for the 75% of the model parameters. Direct methods to reduce DNN size include reducing the number of hidden layers, reducing the input size by using fewer stacked context frames, and reducing the number of hidden nodes per layer; however, Table 1 shows that reducing the number of layers, context size, or hidden units may negatively impact performance. Therefore, in order to limit model size, this disclosure focuses on reducing the size of the first hidden layer using alternative architectures.

TABLE 1

| Layers | Patch | Depth | Weights | Multiplies | EER |
|---|---|---|---|---|---|
| 4 | 48 × 48 | 256 | 787k | 787k | 3.88 |
| 3 | | | 721k | 721k | 4.16 |
| 4 | 48 × 48 | 256 | 787k | 787k | 3.88 |
| | 20 × 48 | | 442k | 442k | 4.05 |
| | 5 × 48 | | 258k | 258k | 5.04 |
| 4 | 48 × 48 | 256 | 787k | 787k | 3.88 |
| | | 128 | 344k | 344k | 5.53 |

Table 1 shows baseline results for various configurations of fully-connected networks: with variable number of layers (top), with variable context sizes (middle) and with variable number of nodes (bottom.) The “Weights” column is the number of weights in each model, and represents the model footprint. The “Multiplies” column corresponds to the number of multiplications required for computing the feed-forward neural net, and represents the latency impact.

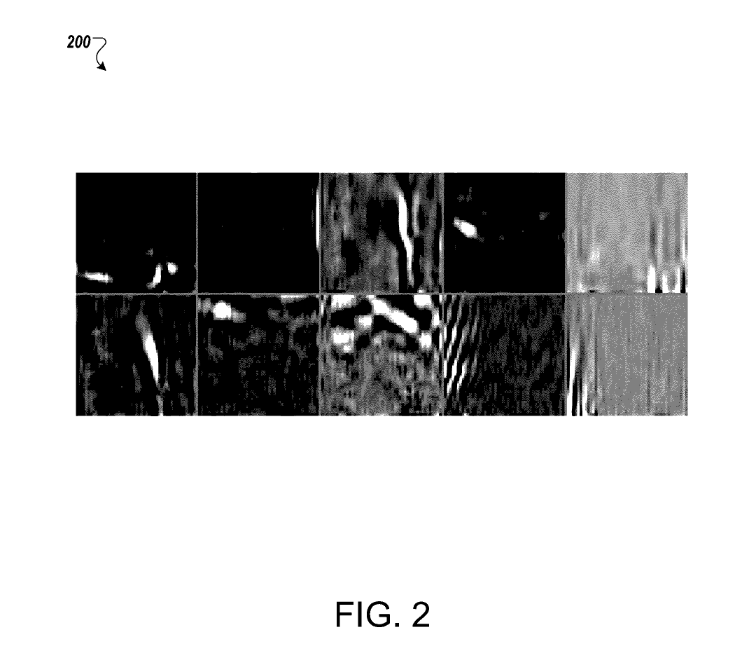

Although the first hidden layer contains most of the baseline fully-connected DNN model's weights, the weight matrices of the first fully-connected hidden layer are very sparse and low-rank. FIG. 2 shows visualizations of the weight matrices from the first hidden layer. Previous approaches have taken note of DNN sparsity and attempted to train networks that are less sparse, or iteratively prune low-value weights. In the exemplary system, it can be seen that the sparse non-zero weights are clumped close together, not scattered throughout the matrix, such that a small patch could span over the well-localized non-zero weights. This is important because parallel SIMD operations may be heavily relied upon in implementations of the techniques described herein to efficiently compute neural nets using small dense matrices rather than large, and sparse matrices. In some examples, LCN and CNN layers may be leveraged to take advantage of the sparse and local nature of the DNN to constrain the model size while improving performance.

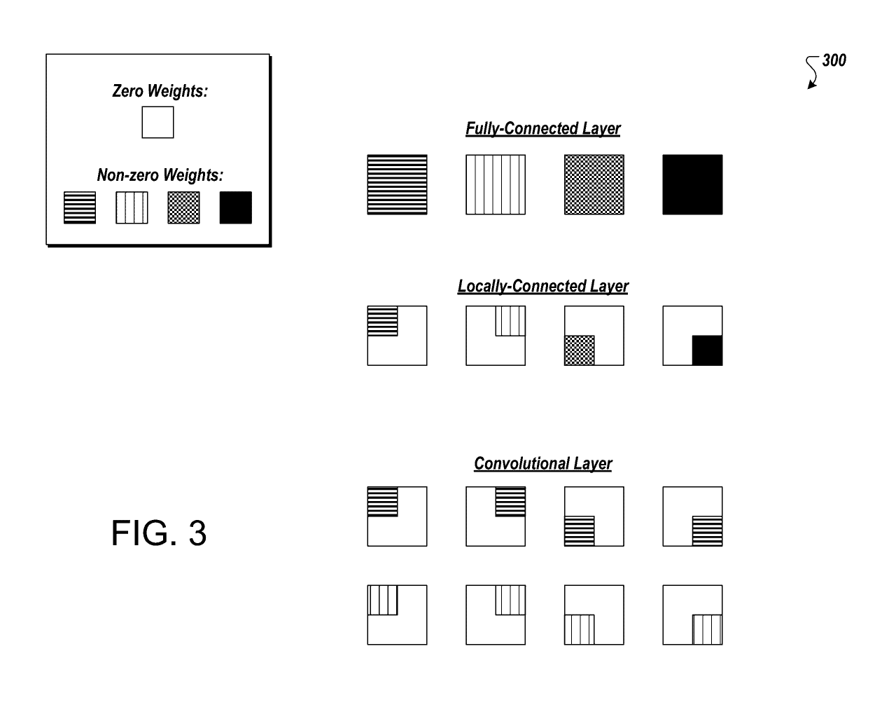

To reduce the model size, experiments included explicitly enforcing sparsity in the first hidden layer by using a LCN layer. When using local connections, each of the hidden activations is the result of processing a locally-connected “patch” of v, rather than all of v as done in fully-connected DNNs. FIG. 3 compares the weight matrices of a fully-connected layer and a LCN layer, emphasizing how a LCN layer is equivalent to a sparse fully-connected layer.

FIG. 3 conceptually illustrates: In a fully-connected input layer, each filter contains non-zero weights for each input element. In a LCN input layer, each filter is only non-zero for a subset of the input elements, and different filters may cover different subsets of the input. While each filter in a LCN layer covers only one patch of the input, each filter in a CNN layer covers all the patches in the input through convolution. Each colored square corresponds to a filter matrix.

The LCN may be implemented with square patches of size p×p that tile the input elements in a grid with no gaps. Let v be the number of input features, p the width and length of the square patch, n=v/p² the number of patches over the input and f_{lcn} is the number of filters over each patch. Then, the total number of filters used by the LCN layer is given by nf_{lcn}, while the number of weights in the network is:

w=vf_{lcn}+nf_{lcn}k+(M−2)k² (3)

Here k denotes the number of nodes of the rest of the hidden layers in the network. Note by comparing (2) and (3) that the variables f_{lcn} and n offer finer control over the number of parameters in the network. The first two hidden layers are influenced by f_{lcn} while remaining hidden layers have k² weights. One interpretation of local connections is that they enforce patch-based sparse matrices when training; given the sparse filters in the first fully-connected hidden layer, e.g., as illustrated in FIG. 3, local connections are a natural fit. By using a LCN layer, a sparse-coding with hand-crafted bases may be implemented.

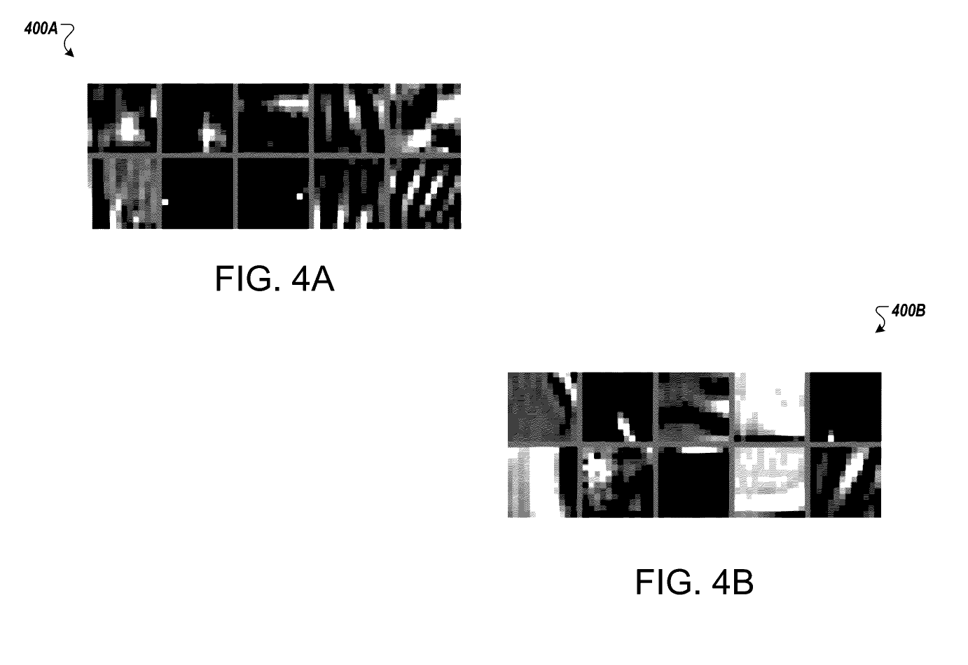

As FIG. 4A shows, several LCN filters appear similar, suggesting further compression is possible. In experimentation, this provided motivation to look at CNNs to reduce model size further. Like LCN, CNN may also define a topology where local receptive fields, or patches, are used to model the local correlations in the input. However, unlike LCN layers—where each filter is applied to a single patch in the input—in CNN layers, filters are convolved, such that all filters are applied to every input patch, see e.g., FIG. 3. This approach may be interpreted as using a unique set of f_{cnn} filters repeated over all patches, versus using n sets of localized filters, each of size f_{lcn}, as in LCN. As several LCN filters appeared similar in FIG. 4A, this strategy of sharing filters suggests that further compression is possible. Furthermore, CNNs may be particularly good in handling noisy or reverberant conditions.

CNN layers take orders of magnitude more multiplications to compute than similarly sized fully-connected or LCN layers. In order to keep latency under 40 ms on target platforms, the experiments described herein were limited to CNN configurations with 1.5M multiplications. Under this constraint, the configurations considered were primarily filters that shift with very large strides of size p when convolving. Pooling layers were not utilized in the exemplary experimentation, as they may reduce speaker variance. Given a 48×48 input, results were provided for CNN layers with four 24×24 patches, sixteen 12×12 patches, or sixty-four 6×6 patches.

The number of weights in a model were computed with CNN first hidden layer as follows. Let v be the number of input features, p the width and length of square patch filter, n=v/p² the number of patches, f_{cnn} be the number filters from first hidden layer, and k be the number of nodes in the rest of the hidden layers; then the number of weights for a CNN model is:

w=f_{cnn}p²nf_{cnn}k(M−2)k² (4)

Unlike fully-connected and LCN models, the number of multiplications necessary to compute the CNN model may not equal to the number of model weights. The number of multiplications required to compute a CNN model is:

vf_{cnn}+nf_{cnn}k+(M−2)k² (5)

Some of the filters learned by CNN layer can be seen in FIG. 4B. The CNN filters appear to be smoother and sparser than the LCN filters in FIG. 4A.

Various examples of different models are discussed below with respect to a small footprint global password TD-speaker verification task. The training set for the exemplary neural networks contains 3200 anonymized speakers speaking a predetermined phrase, with an average of ˜745 repetitions per speaker. Repetitions are recorded in multiple sessions in a wide variety of environments, including multiple devices and languages. A non-overlapped set of 3000 speakers are present for enrollment and evaluation. Each speaker in the evaluation set enrolls with 3 to 9 utterances and it is evaluated with 7 positive utterances. In the results, all possible trials were considered, leading to ˜21 k target trials and ˜6.3M non-target trials. Results are reported in Equal Error Rate (EER).

In one example, the hidden layers contain 256 nodes, but other configurations may be used. Several variations of the first hidden layer can be used also. As an example, a system can include a 4 hidden layers of 256 nodes each, described above. A DNN may be enhanced by: (a) replacing maxout layers with fully-connected layers with rectified linear units, (b) replacing an average function with the dimension-wise max function, see e.g., Eq. 1, (c) using matrices of, for example, 48×48 elements so as to provide additional flexibility in the configuration of patches. Note that 48×48 facilitates the definition of square patches as it is divisible by 24, 12, 8, 6, 4, 3, and 2.

Various architectures can modify the first hidden layer, and some implementations may fix the last three hidden layers as fully-connected layers with 256 nodes. These last three layers may include, for example, 66 k weight parameters each. For LCN layers and CNN layers, examples of patch sizes include 24×24, 12×12, and 6×6 sizes. In order to achieve 256 output nodes from the first hidden layer, the depth of each layer may be varied with the type of layer and patch size. For example, a fully-connected layer with depth of 256 would have 256 output nodes. A LCN layer with 24×24 patch size with depth of 64 would generate 4 patches with depth 64, for a total of 256 output nodes as well.

Table 2 shows the configuration and equal error rate (EER) for various different example models, as well as model footprint and latency information. The examples shown below indicate that a baseline fully-connected first hidden layer can be reduced from 590 k parameters to 37 k (6% of baseline layer) parameters with about 4% increase in EER by using a LCN layer with 12×12 patches or a CNN layer with 24×24 patches. For 4% increase in EER, LCN and CNN models that are 30% the size of the baseline model can be implemented; in this experiment, the best LCN model and the best CNN model have the same number of parameters and similar EER.

TABLE 2

| | Patch | Depth | Weights | Multiplies | EER |
|---|---|---|---|---|---|
| Fully | 48 × 48 | 256 | 787k | 787k | 3.88 |
| LCN | 24 × 24 | 64 | 345k | 345k | 4.11 |
| | 12 × 12 | 16 | 234k | 234k | 4.02 |
| | 6 × 6 | 4 | 206k | 206k | 4.54 |
| CNN | 24 × 24 | 64 | 234k | 345k | 4.04 |
| | 12 × 12 | 16 | 199k | 234k | 4.24 |
| | 6 × 6 | 4 | 197k | 206k | 4.45 |

Table 2 allows comparison of fully-connected, LCN, and CNN first hidden layers. First hidden layer has 256 outputs, while the remaining hidden layers have 256 inputs and 256 outputs. “Weights” corresponds to model size, indicating the number of parameter values that need to be stored. “Multiplies” corresponds to latency, indicating a number of operations needed to be performed for propagation thorough the network.

Additional examples allow a reduction in model size, allowing the EER to increase above that of a baseline or fully-connected model. For purposes of illustration, model size can be matched across different models. The model size is important for resource-constrained platforms, for example, devices having limited storage space and processing capacity such as smartphones, watches, wearable devices, and so on. To match a given model size, the first hidden layer is not constrained to have 256 hidden units in these examples, allowing an increase in the depth of the LCN and CNN layers. In these examples, the last two hidden layers are fully-connected, have 256 inputs and outputs, and contain 66 k weights.

Table 3 shows the EER, number of weights (model size), and number of multiplications (latency) for each example model. When parameters are matched, LCN and CNN models generally have smaller EER than that of the baseline fully-connected model. With approximately the same number of weights and multiplications, LCN model with 12×12 patches may have an EER that is lower than baseline model. With approximately the same number of weights and more multiplications, the CNN model with 24×24 patches has EER that is lower than the baseline model. When the number of model parameters is held constant, CNN models may have better performance than LCN models.

TABLE 3

| | Patch | Depth | Weights | Multiplies | EER |
|---|---|---|---|---|---|
| Fully | 48 × 48 | 256 | 787k | 787k | 3.88 |
| LCN | 24 × 24 | 197 | 787k | 787k | 3.71 |
| | 12 × 12 | 102 | 784k | 784k | 3.60 |
| | 6 × 6 | 35 | 786k | 786k | 3.75 |
| CNN | 24 × 24 | 411 | 789k | 1499k | 3.52 |
| | 24 × 24 | 154 | 785k | 1117k | 3.75 |
| | 24 × 24 | 40 | 788k | 879k | 3.87 |

Table 3 shows results when using a matching total number of parameters, holding last 2 hidden layers constant while varying the first 2 hidden layers. “Weights” corresponds to model size. “Multiplies” corresponds to latency.

As discussed above, two neural network layer architectures were compared to a fully-connected baseline for small footprint text-dependent speaker verification. Both LCN and CNN layers can be used to shrink model size. For example, in some instances, model size may be approximately 30% of the baseline model size with only a small relative increase in EER (Table 2). When model size is held constant, the CNN model technique is preferred because it may reduce baseline EER by a greater degree than an LCN model of the same size (Table 3). If latency, which corresponds to number of model multiplications, is constrained, then the LCN model is preferred because it often uses significantly fewer multiplications than a similarly-sized CNN model.

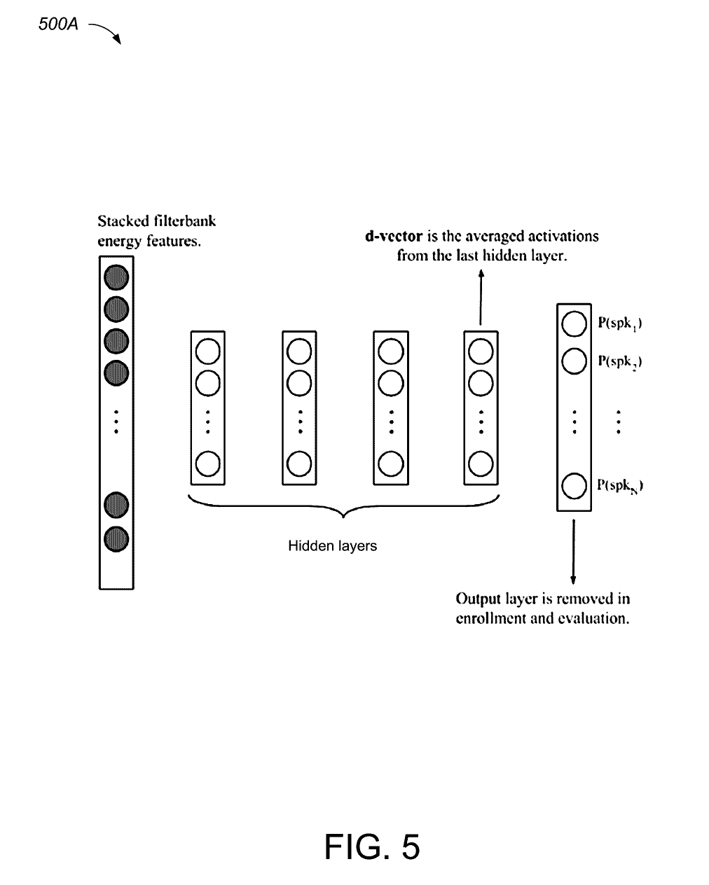

Techniques for speaker verification are discussed in greater detail with respect to FIGS. 5-13. In general, the speaker verification process can be divided into three phases, training, enrollment, and evaluation. For training, in some implementations, background models may be trained from a large collection of data to define the speaker manifold. Examples of background models include Gaussian mixture model (GMM) based Universal Background Models (UBMs) and Joint Factor Analysis (JFA) based models. For enrollment, in general, new speakers are enrolled by deriving speaker-specific information to obtain speaker-dependent models. In some implementations, new speakers may be assumed to not be in the background model training data. For evaluation, in some implementations, each test utterance is evaluated using the enrolled speaker models and background models. For example, a decision may be made on the identity claim.

A wide variety of speaker verification systems have been studied using different statistical tools for each of the three phases in verification. Some speaker verification systems use i-vectors and Probabilistic Linear Discriminant Analysis (PLDA). In these systems, JFA is used as a feature extractor to extract a low-dimensional i-vector as the compact representation of a speech utterance for speaker verification.

To apply the powerful feature extraction capability of neural networks, e.g., deep neural networks (DNNs), to speech recognition, a speaker verification technique based on a DNN may be implemented as the speaker feature extractor. In some implementations, the DNN-based background model may be used to directly model the speaker space. For example, a DNN may be trained to map frame-level features in a given context to the corresponding speaker identity target. During enrollment, the speaker model may be computed as a deep vector (“d-vector”), the average of activations derived from the last DNN hidden layer. In the evaluation phase, decisions may be made using the distance between the target d-vector and the test d-vector. In some instances, DNNs used for speaker verification can be integrated into other speech recognition systems by sharing the same DNN inference engine and simple filterbank energies frontend.

FIG. 5 is a block diagram of an example system 500A that uses a DNN model for speaker verification. In general, neural networks are used to learn speaker specific features. In some implementations, supervised training may be performed.

In general, a DNN architecture may be used as a speaker feature extractor. An abstract and compact representation of the speaker acoustic frames may be implemented using a DNN rather than a generative Factor Analysis model.

In some implementations, a supervised DNN, operating at the frame level, may be used to classify the training set speakers. For example, the input of this background network may be formed by stacking each training frame with its left and right context frames. The number of outputs may correspond to the number of speakers in the training set, N. The target labels may be formed as a 1-hot N-dimensional vector where the only non-zero component is the one corresponding to the speaker identity.

In some implementations, once the DNN has been trained successfully, the accumulated output activations of the last hidden layer may be used as a new speaker representation. For example, for every frame of a given utterance belonging to a new speaker, the output activations of the last hidden layer may be computed using standard feedforward propagation in the trained DNN, and then accumulate those activations to form a new compact representation of that speaker, the d-vector. By using the output from the last hidden layer instead of the softmax output layer the DNN model size for runtime may be reduced by pruning away the output layer, and a large number of training speakers may be used without increasing DNN size at runtime. In addition, using the output of the last hidden layer can enhance generalization to unseen speakers.

In some implementations, the trained DNN, having learned compact representations of the training set speakers in the output of the last hidden layer, may also be able to represent unseen speakers.

In some implementations, given a set of utterances Xs={Os1, Os2, . . . Osn} from a speaker s, with observations Osi={o1, o2, . . . , om}, the process of enrollment may be described as follows. First, every observation oj in utterance Osi, together with its context, may be used to feed the supervised trained DNN. The output of the last hidden layer may then be obtained, L2 normalized, and accumulated for all the observations oj in Osi. The resulting accumulated vector may be referred to as the d-vector associated with the utterance Osi. The final representation of the speaker s may be derived by averaging all d-vectors corresponding for utterances in Xs.

In some implementations, during the evaluation phase, the normalized d-vector may be extracted from the test utterance. The cosine distance between the test d-vector and the claimed speaker's d-vector may then be computed. A verification decision may be made by comparing the distance to a threshold.

In some implementations, the background DNN may be trained as a maxout DNN using dropout. Dropout is a useful strategy to prevent over-fitting in DNN fine-tuning when using a small training set. In some implementations, the dropout training procedure may include randomly omitting certain hidden units for each training token. Maxout DNNs may be conceived to properly exploit dropout properties. Maxout networks differ from the standard multi-layer perceptron (MLP) in that hidden units at each layer are divided into non-overlapping groups. Each group may generate a single activation via the max pooling operation. Training of maxout networks can optimize the activation function for each unit.

As one example, a maxout DNN may be trained with four hidden layers and 256 nodes per layer, within the DistBelief framework. Alternatively, a different number of layers (e.g., 2, 3, 5, 8, etc.) or a different number of nodes per layer (e.g., 16, 32, 64, 128, 512, 1024, etc.) may be used. A pool size of 2 is used per layer, but the pool size used may be greater or fewer than this, e.g., 1, 3, 5, 10, etc.

In some implementations, dropout techniques are used at fewer than all of the hidden layers. For example, the initial hidden layers may not use dropout, but the final layers may use drop out. In the example of FIG. 5, the first two layers do not use dropout while the last two layers drop 50 percent of activations after dropout. As an alternative, at layers where dropout is used, the amount of activations dropped may be, for example, 10 percent, 25 percent, 40 percent, 60 percent, 80 percent, etc.

Rectified linear units may be used as the non-linear activation function on hidden units and a learning rate of 0.001 with exponential decay (0.1 every 5M steps). Alternatively, a different learning rate (e.g., 0.1, 0.01, 0.0001, etc.) or a different number of steps (e.g., 0.1M, 1M, 10M, etc.) may be used. The input of the DNN is formed by stacking the 40-dimensional log filterbank energy features extracted from a given frame, together with its context, 30 frames to the left and 10 frames to the right. The dimension of the training target vectors can be the same as the number of speakers in the training set. For example, if 500 speakers are in the training set, then the training target can have a dimension of 500. A different number of speakers can be used, e.g., 50, 100, 200, 750, 1000, etc. The final maxout DNN model contains about 600K parameters. Alternatively, final maxout DNN model may contain more or fewer parameters (e.g., 10 k, 100 k, 1M, etc.).

As discussed above, a DNN-based speaker verification method can be used for a small footprint text-dependent speaker verification task. DNNs may be trained to classify training speakers with frame-level acoustic features. The trained DNN may be used to extract speaker-specific features. The average of these speaker features, or d-vector, may be used for speaker verification.

In some implementations, a DNN-based technique and an i-vector-based technique can be used together to verify speaker identity. The d-vector system and the i-vector system can each generate a score indicating a likelihood that an utterance corresponds to an identity. The individual scores can be normalized, and the normalized scores may then be summed or otherwise combined to produce a combined score. A decision about the identity can then be made based on comparing the combined score to a threshold. In some instances, the combined use of an i-vector approach and a d-vector approach may outperform either approach used individually.

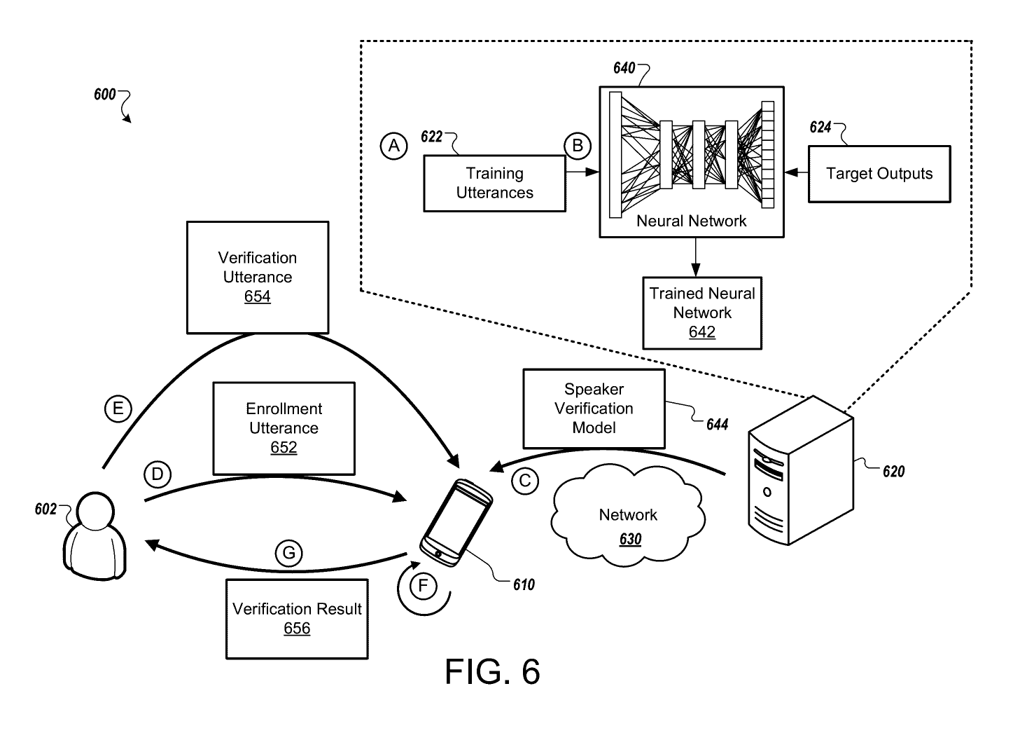

FIG. 6 is a block diagram of an example system 600 that can verify a user's identity using a speaker verification model based on a neural network. Briefly, a speaker verification process is the task of accepting or rejecting the identity claim of a speaker based on the information from his/her speech signal. In general, the speaker verification process includes three phases, (i) training of the speaker verification model, (ii) enrollment of a new speaker, and (iii) verification of the enrolled speaker.

The system 600 includes a client device 610, a computing system 620, and a network 630. In some implementations, the computing system 620 may provide a speaker verification model 644 based on a trained neural network 642 to the client device 610. The client device 610 may use the speaker verification model 644 to enroll the user 602 to the speaker verification process. When the identity of the user 602 needs to be verified at a later time, the client device 610 may receive speech utterance of the user 602 to verify the identity of the user 602 using the speaker verification model 644.

Although not shown in FIG. 6, in some other implementations, the computing system 620 may store the speaker verification model 644 based on the trained neural network 642. The client device 610 may communicate with the computing system 620 through the network 630 to use the speaker verification model 644 to enroll the user 602 to the speaker verification process. When the identity of the user 602 needs to be verified at a later time, the client device 610 may receive speech utterance of the user 602, and communicate with the computing system 620 through the network 630 to verify the identity of the user 602 using the speaker verification model 644.

In the system 600, the client device 610 can be, for example, a desktop computer, laptop computer, a tablet computer, a wearable computer, a cellular phone, a smart phone, a music player, an e-book reader, a navigation system, or any other appropriate computing device. The functions performed by the computing system 620 can be performed by individual computer systems or can be distributed across multiple computer systems. The network 630 can be wired or wireless or a combination of both and can include the Internet.

In some implementations, a client device 610, such as a phone of a user, may store a speaker verification model 644 locally on the client device 610, allowing the client device 610 to verify a user's identity without reaching out to a remote server (e.g., the computing system 620) for either the enrollment or the verification process, and therefore may save communications bandwidth and time. Moreover, in some implementations, when enrolling one or more new users, the speaker verification model 644 described here does not require any retraining of the speaker verification model 644 using the new users, which also is computationally efficient.

It is desirable that the size of the speaker verification model 644 be compact because the memory space on the client device 610 may be limited. As described below, the speaker verification model 644 is based on a trained neural network. The neural network may be trained using a large set of training data, and may generate a large amount of data at the output layer. However, the speaker verification model 644 may be constructed by selecting only certain layers of the neural network, which may result in a compact speaker verification model suitable for the client device 610.

FIG. 6 also illustrates an example flow of data, shown in stages (A) to (F). Stages (A) to (F) may occur in the illustrated sequence, or they may occur in a sequence that is different than in the illustrated sequence. In some implementations, one or more of the stages (A) to (F) may occur offline, where the computing system 620 may perform computations when the client device 610 is not connected to the network 630.

During stage (A), the computing system 620 obtains a set of training utterances 622, and inputs the set of training utterances 622 to a supervised neural network 640. In some implementations, the training utterances 622 may be one or more predetermined words spoken by the training speakers that were recorded and accessible by the computing system 620. Each training speaker may speak a predetermined utterance to a computing device, and the computing device may record an audio signal that includes the utterance. For example, each training speaker may be prompted to speak the training phrase “Hello Phone.” In some implementations, each training speaker may be prompted to speak the same training phrase multiple times. The recorded audio signal of each training speaker may be transmitted to the computing system 620, and the computing system 620 may collect the recorded audio signals and select the set of training utterances 622. In other implementations, the various training utterances 622 may include utterances of different words.

During stage (B), the computing system 620 uses the training utterances 622 to train a neural network 640, resulting in a trained neural network 642. In some implementations, the neural network 640 is a supervised deep neural network.

During training, information about the training utterances 622 is provided as input to the neural network 640. Training targets 624, for example, different target vectors, are specified as the desired outputs that the neural network 640 should produce after training. For example, the utterances of each particular speaker may correspond to a particular target output vector. One or more parameters of the neural network 640 are adjusted during training to form a trained neural network 642.

For example, the neural network 640 may include an input layer for inputting information about the training utterances 622, several hidden layers for processing the training utterances 622, and an output layer for providing output. The weights or other parameters of one or more hidden layers may be adjusted so that the trained neural network produces the desired target vector corresponding to each training utterance 622. In some implementations, the desired set of target vectors may be a set of feature vectors, where each feature vector is orthogonal to other feature vectors in the set. For example, speech data for each different speaker from the set of training speakers may produce a distinct output vector at the output layer using the trained neural network. In some implementations, one or more layers of the neural network 640 may be only partially connected to an adjacent layer, for example, a locally connected layer or a convolutional layer. In other implementations, one or more layers of the neural network 640 may be fully-connected to an adjacent layer.

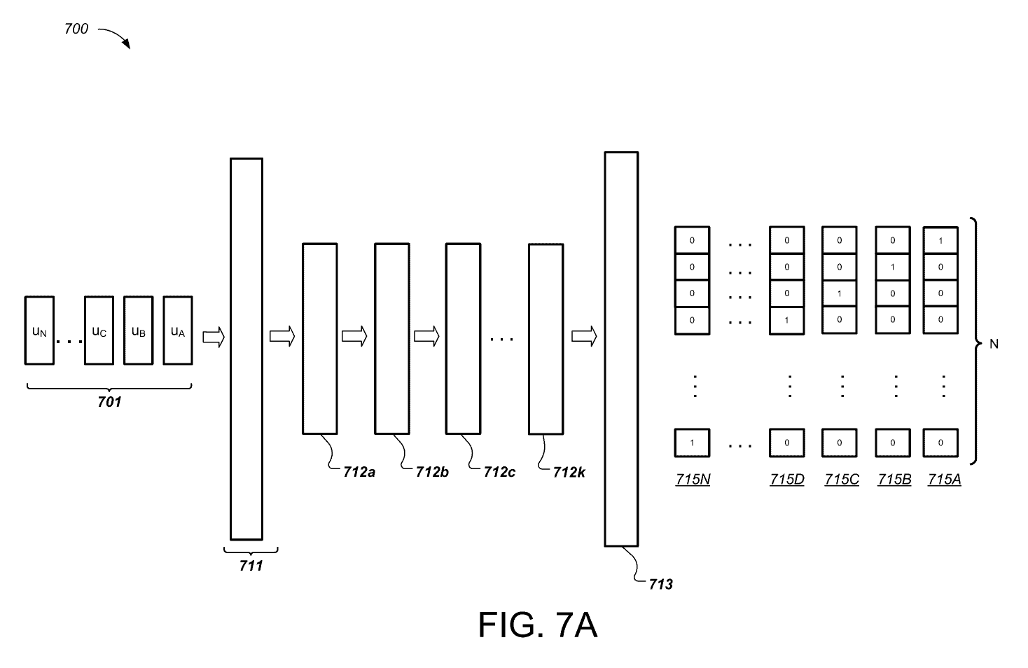

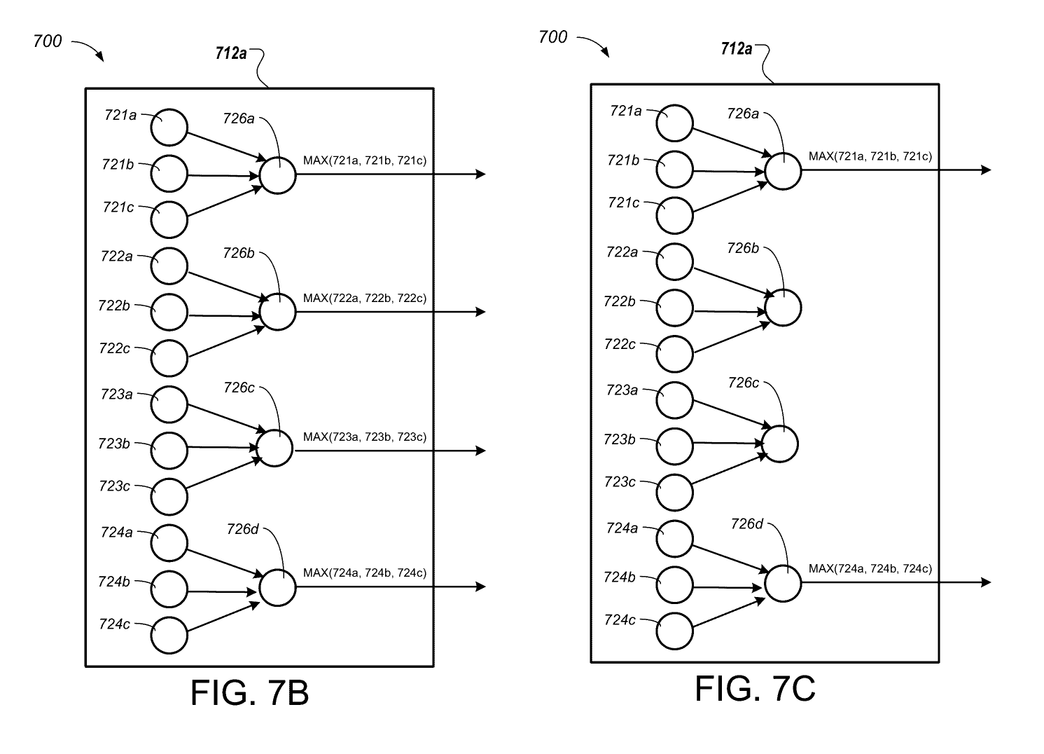

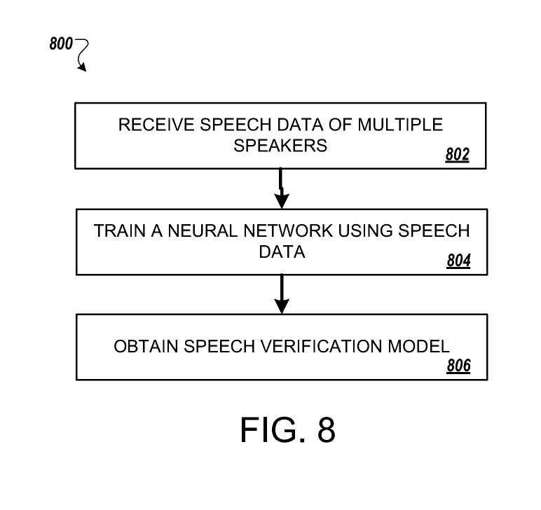

The neural network that generates the desired set of speaker features may be designated as the trained neural network 642. In some implementations, the parameters of the supervised neural network 640 may be adjusted automatically by the computing system 620. In some other implementations, the parameters of the supervised neural network 640 may be adjusted manually by an operator of the computing system 620. The training phase of a neural network is described in more details below in descriptions of FIGS. 7A, 7B, 7C, and 8.

During stage (C), once the neural network has been trained, a speaker verification model 644 based on the trained neural network 642 is transmitted from the computing system 620 to the client device 610 through the network 630. In some implementations, the speaker verification model 644 may omit one or more layers of the neural network 642, so that the speaker verification model 644 includes only a portion of, or subset of, the trained neural network 642. For example, the speaker verification model 644 may include the input layer and the hidden layers of the trained neural network 642, and use the last hidden layer of the trained neural network 642 as the output layer of the speaker verification model 644. As another example, the speaker verification model 644 may include the input layer of the trained neural network 642, and the hidden layers that sequentially follow the input layer, up to a particular hidden layer that has been characterized to have a computation complexity exceeding a threshold.

During stage (D), a user 602 who desires to enroll her voice with the client device 610 provides one or more enrollment utterances 652 to the client device 610 in the enrollment phase. In general, the user 602 is not one of the training speakers that generated the set of training utterances 622. In some implementations, the user client device 610 may prompt the user 602 to speak an enrollment phrase that is the same phrase spoken by the set of training speakers. In some implementations, the client device 610 may prompt the user to speak the enrollment phrase several times, and record the spoken enrollment utterances as the enrollment utterances 652.

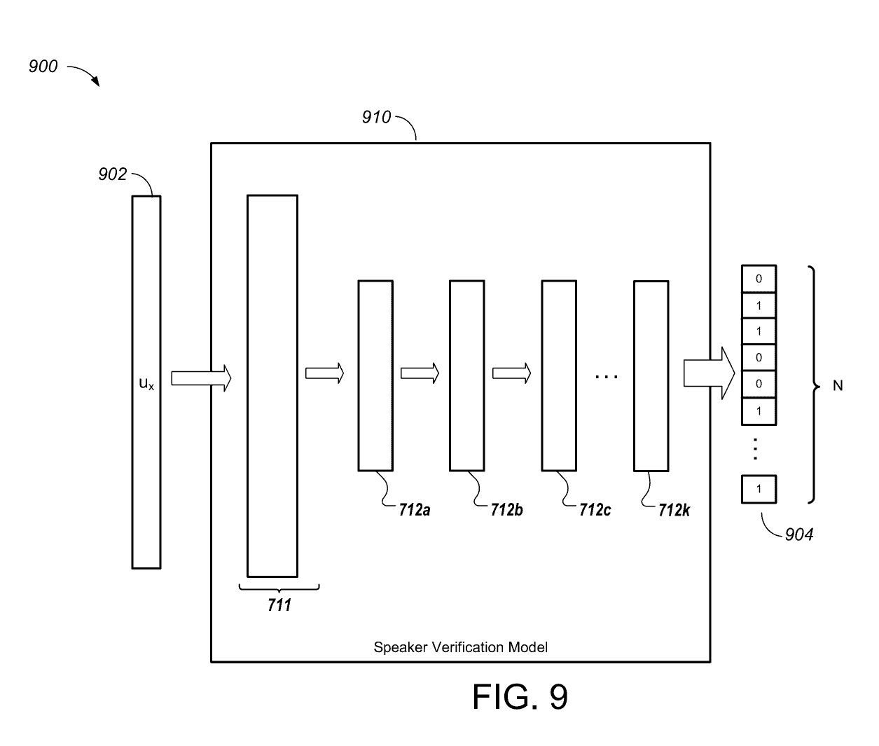

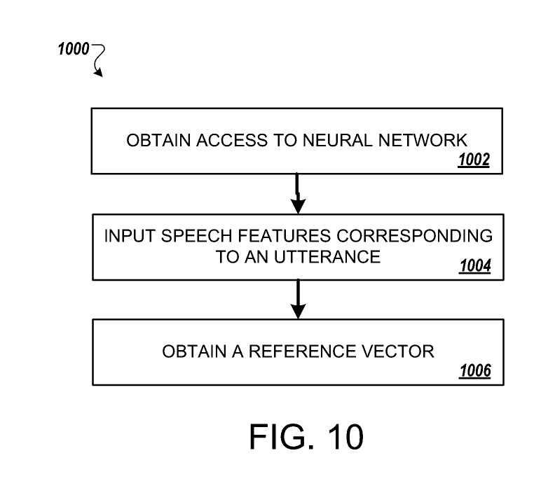

The client device 610 uses the enrollment utterances 652 to enroll the user 602 in a speaker verification system of the client device 610. In general, the enrollment of the user 602 is done without retraining the speaker verification model 644 or any other neural network. The same speaker verification model 644 may be used at many different client devices, and for enrolling many different speakers, without requiring changing the weight values of other parameters in a neural network. Because the speaker verification model 644 can be used to enroll any user without retraining a neural network, enrollment may be done at the client device 610 with limited processing requirements. In some implementations, information about the enrollment utterances 652 is input to the speaker verification model 644, and the speaker verification model 644 may output a reference vector corresponding to the user 602. The output of the speaker vector may represent characteristics of the user's voice. The client device 600 stores this reference vector for later use in verifying the voice of the user 602. The enrollment phase of a neural network is described in more details below in descriptions of FIGS. 9 and 10.

During stage (E), the user 602 attempts to gain access to the client device 610 using voice authentication. The user 602 provides a verification utterance 654 to the client device 610 in the verification phase. In some implementations, the verification utterance 654 is an utterance of the same phrase that was spoken as the enrollment utterance 652. The verification utterance 654 is used as input to the speaker verification model 644.

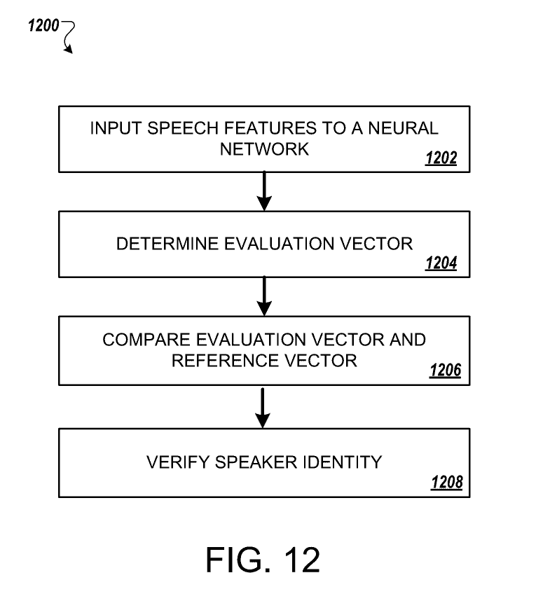

During stage (F), the client device 610 determines whether the user's voice is a match to the voice of the enrolled user. In some implementation, the speaker verification model 644 may output an evaluation vector that corresponds to the verification utterance 654. In some implementations, the client device 610 may compare the evaluation vector with the reference vector of the user 602 to determine whether the verification utterance 654 was spoken by the user 602. The verification phase of a neural network is described in more details below in FIGS. 11 and 12.

During stage (G), the client device 610 provides an indication that represents a verification result 656 to the user 602. In some implementations, if the client device 610 has accepted the identity of the user 602, the client device 610 may send the user 602 a visual or audio indication that the verification is successful. In some other implementations, if the client device 610 has accepted the identity of the user 602, the client device 610 may prompt the user 602 for a next input. For example, the client device 610 may output a message “Device enabled. Please enter your search” on the display. In some other implementations, if the client device 610 has accepted the identity of the user 602, the client device 610 may perform a subsequent action without waiting for further inputs from the user 602. For example, the user 602 may speak “Hello Phone, search the nearest coffee shop” to the client device 610 during the verification phase. The client device 610 may verify the identity of the user 602 using the verification phrase “Hello Phone.” If the identity of the user 602 is accepted, the client device 610 may perform the search for the nearest coffee shop without asking the user 602 for further inputs.

In some implementations, if the client device 610 has rejected the identity of the user 602, the client device 610 may send the user 602 a visual or audio indication that the verification is rejected. In some implementations, if the client device 610 has rejected the identity of the user 602, the client device 610 may prompt the user 602 for another utterance attempt. In some implementations, if the number of attempts exceeds a threshold, the client device 610 may disallow the user 602 from further attempting to verify her identity.

FIG. 7A is a block diagram of an example neural network 700 for training a speaker verification model. The neural network 700 includes an input layer 711, a number of hidden layers 712a-712k, and an output layer 713. The input layer 711 receives data about the training utterances. During training, one or more parameters of one or more hidden layers 712a-712k of the neural network are adjusted to form a trained neural network. The output layer can also be adjusted during training. For example, one or more hidden layers may be adjusted to obtain different target vectors corresponding to the different training utterances 622 until a desired set of target vectors are formed. In some implementations, the desired set of target vectors may be a set of feature vectors, where each feature vector is orthogonal to other feature vectors in the set. For example, for N training speakers, the neural network 700 may output N vectors, each vector corresponding to the speaker features of the one of the N training speakers.

As discussed above, one or more of the hidden layers 712a-712k may be locally-connected layers or convolutional layers. In particular, the first hidden layer 712a may be a locally-connected layer or convolutional layer. For example, a locally-connected layer can enforce sparsity in the first hidden layer so that various nodes in the first hidden layer 712a receive only a subset of the activations at the input layer. Each hidden layer may be the result of processing a locally-connected patch of the total input set. In a CNN layer, a filter is convolves so that each filter is applied to each input patch.

A set of input vectors 701 for use in training is determined from sample utterances from multiple speakers. In the example, the value N represents the number of training speakers whose speech samples are used for training. The input vectors 701 are represented as {u_{A}, u_{B}, u_{C}, . . . , u_{N}}. The input vector u_{A} represents characteristics of an utterance of speaker A, the input vector u_{B} represents characteristics of an utterance of speaker B, and so on. For each of the different training speakers, a corresponding target vector 715A-715N is assigned as a desired output of the neural network in response to input for that speaker. For example, the target vector 715A is assigned to Speaker A. When trained, the neural network should produce the target vector 715A in response to input that describes an utterance of Speaker A. Similarly, the target vector 715B is assigned to Speaker B, the target vector 715C is assigned to Speaker C, and so on.

In some implementations, training utterances may be processed to remove noises associated with the utterances before deriving the input vectors 701 from the utterances. In some implementations, each training speaker may have spoken several utterances of the same training phrase. For example, each training speaker may have been asked to speak the phrase “hello Google” ten times to form the training utterances. An input vector corresponding to each utterance, e.g., each instance of the spoken phrase, may be used during training. As an alternative, characteristics of multiple utterances may be reflected in a single input vector. The set of training utterances 701 are processed sequentially through hidden layers 712a, 712b, 712c, to 712k, and the output layer 713.

In some implementations, the neural network 700 may be trained under machine or human supervision to output N orthogonal vectors. For each input vector 701, the output at the output layer 713 may be compared to the appropriate target vector 715A-715N, and updates to the parameters of the hidden layers 712a-712k are made until the neural network produces the desired target output corresponding to the input at the input layer 711. For example, techniques such as backward propagation of errors, commonly referred to as backpropagation, may be used to train the neural network. Other techniques may additionally or alternatively be used. When training is complete, for example, the output vector 715A may be a 1-by-N vector having a value of [1, 0, 0, . . . , 0], and corresponds to the speech features of utterance u_{A}. Similarly, the output vector 715B is another 1-by-N vector having a value of [0, 1, 0, . . . , 0], and corresponds to the speech features of utterance u_{B}.

The hidden layers 712a-712k can have various different configurations, as described further with respect to FIGS. 7B and 7C below. For example, rectified linear units may be used as the non-linear activation function on hidden units and a learning rate of 0.001 with exponential decay (0.1 every 5M steps). Alternatively, a different learning rate (e.g., 0.1, 0.01, 0.0001, etc.) or a different number of steps (e.g., 0.1M, 1M, 10M, etc.) may be used. In some implementations, one or more layers of the neural network 700 may be only partially connected to an adjacent layer, for example, a locally connected layer or a convolutional layer. In other implementations, one or more layers of the neural network 700 may be fully-connected to an adjacent layer.

In some implementations, once the neural network 700 is trained, a speech verification model may be obtained based on the neural network 700. In some implementations, the output layer 713 may be excluded from the speech verification model, which may reduce the size of the speech verification model or provide other benefits. For example, a speech verification model trained based on speech of 500 different training speakers may have a size of less than 1 MB.

FIG. 7B is a block diagram of an example neural network 700 having a hidden layer 712a that implements the maxout feature.

In some implementations, the neural network 700 may be trained as a maxout neural network. Maxout networks differ from the standard multi-layer perceptron (MLP) networks in that hidden units, e.g., nodes or neurons, at each layer are divided into non-overlapping groups. Each group may generate a single activation via the max pooling operation. For example, the hidden layer 712a shows four hidden nodes 226a-226d, with a pool size of three. Each of the nodes 721a, 721b, and 721c produces an output, but only the maximum of the three outputs is selected by node 226a to be the input to the next hidden layer. Similarly, each of the nodes 722a, 722b, and 722c produces an output, but only the maximum of the three outputs is selected by node 226b to be the input to the next hidden layer.

Alternatively, a different number of layers (e.g., 2, 3, 5, 8, etc.) or a different number of nodes per layer (e.g., 16, 32, 64, 128, 512, 1024, etc.) may be used. A pool size of 2 is used per layer, but the pool size used may be greater or fewer than this, e.g., 1, 3, 5, 10, etc.

FIG. 7C is a block diagram of an example neural network 700 having a hidden layer 712a that implements a maxout neural network feature using the dropout feature.

In some implementations, the neural network 700 may be trained as a maxout neural network using dropout. In general, dropout is a useful strategy to prevent over-fitting in neural network fine-tuning when using a small training set. In some implementations, the dropout training procedure may include randomly selecting certain hidden nodes of one or more hidden layers, such that output from these hidden nodes are not provided to the next hidden layer.

In some implementations, dropout techniques are used at fewer than all of the hidden layers. For example, the initial hidden layers may not use dropout, but the final layers may use drop out. As another example, the hidden layer 712a shows four hidden nodes 226a-226d, with a pool size of three, and a dropout rate of 50 percent. Each of the nodes 721a, 721b, and 721c produces an output, but only the maximum of the three outputs is selected by node 226a to be the input to the next hidden layer. Similarly, each of the nodes 722a, 722b, and 722c produces an output, but only the maximum of the three outputs is selected by node 226b to be the input to the next hidden layer. However, the hidden layer 712a drops 50 percent of activations as a result of dropout. Here, only the outputs of nodes 226a and 226d are selected as input for the next hidden layer, and the outputs of nodes 226b and 226c are dropped. As an alternative, at layers where dropout is used, the amount of activations dropped may be, for example, 10 percent, 25 percent, 40 percent, 60 percent, 80 percent, etc.

FIG. 8 is a flow diagram that illustrates an example process 800 for training a speaker verification model. The process 800 may be performed by data processing apparatus, such as the computing system 620 described above or another data processing apparatus.

The system receives speech data corresponding to utterances of multiple different speakers (802). For example, the system may receive a set of training utterances. As another example, the system may receive feature scores that indicate one or more audio characteristics of the training utterances. As another example, using the training utterances, the system may determine feature scores that indicate one or more audio characteristics of the training utterances. In some implementations, the feature scores representing one or more audio characteristics of the training utterances may be used as input to a neural network.

The system trains a neural network using the speech data (804). In some implementations, the speech from each of the multiple different speakers may be designated as corresponding to a different output at an output layer of the neural network. In some implementations, the neural network may include multiple hidden layers.

In some implementations, training a neural network using the speech data may include a maxout feature, where for a particular hidden layer of the multiple hidden layers, the system compares output values generated by a predetermined number of nodes of the particular hidden layer, and outputs a maximum output value of the output values based on comparing the output values.

In some implementations, training a neural network using the speech data may include a dropout feature, where for a particular node of a particular hidden layer of the multiple hidden layers, the system determines whether to output an output value generated by the particular node based on a predetermined probability.

The system obtains a speech verification model based on the trained neural network (806). In some implementations, a number of layers of the speech verification model is fewer than a number of layers of the trained neural network. As a result, the output of the speech verification model is the outputs from a hidden layer of the trained neural network. For example, the speaker verification model may include the input layer and the hidden layers of the trained neural network, and use the last hidden layer of the trained neural network as the output layer of the speaker verification model. As another example, the speaker verification model may include the input layer of the trained neural network, and the hidden layers that sequentially follow the input layer, up to a particular hidden layer that has been characterized to have a computation complexity exceeding a threshold.

FIG. 9 is a block diagram of an example speaker verification model 900 for enrolling a new user. In general, the new user is not one of the training speakers that generated the set of training utterances. In some implementations, a user client device storing the speaker verification model 900 may prompt the new user to speak an enrollment phrase that is the same phrase spoken by the set of training speakers. Alternatively, a different phrase may be spoken. In some implementations, the client device may prompt the new user to speak the enrollment phrase several times, and record the spoken enrollment utterances as enrollment utterances. The output of the speaker verification model 900 may be determined for each of the enrollment utterances. The output of the speaker verification model 900 for each enrollment utterance may be accumulated, e.g., averaged or otherwise combined, to serve as a reference vector for the new user.

In general, given a set of utterances Xs={Oₛ₁, Oₛ₂, . . . Oₛₙ} from a speaker s, with observations Oₛᵢ={o₁, o₂, . . . , oₘ}, the process of enrollment may occur as follows. First, every observation oⱼ in utterance Oₛᵢ, together with its context, may be used to feed a speech verification model. In some implementations, the output of the last hidden layer may then be obtained, normalized, and accumulated for all the observations oⱼ in Oₛᵢ. The resulting accumulated vector may be referred to as a reference vector associated with the utterance Oₛᵢ. In some implementations, the final representation of the speaker s may be derived by averaging all reference vectors corresponding for utterances in Xₛ.

For example, a speaker verification model 910 is obtained from the neural network 700 as described in FIG. 7A. The speaker verification model 910 includes the input layer 711, and hidden layers 712a-712k of the neural network 700. However, the speaker verification model 910 does not include the output layer 713. When speech features for an enrollment utterance 902 are input to the speaker verification model, the speaker verification model 910 uses the last hidden layer 712k to generate a vector 904.

In some implementations, the vector 904 is used as a reference vector, e.g., a voiceprint or unique identifier, that represents characteristics of the user's voice. In some implementations, multiple speech samples are obtained from the user, and a different output vector is obtained from the speaker verification model 910 for each of the multiple speech samples. The various vectors resulting from the different speech samples can be combined, e.g., averaged or otherwise accumulated, to form a reference vector. The reference vector can serve as a template or standard that can be used to identify the user. As discussed further below, outputs from the speaker verification model 910 can be compared with the reference vector to verify the user's identity.

Here, the reference vector 904 is a 1-by-N vector. The reference vector may have the same dimension as any one of the vectors 715A-715N, or may have a different dimension, since the reference vector 904 is obtained from layer 712k and not output layer 713 shown in FIG. 7A. The reference vector 904 has values of [0, 1, 1, 0, 0, 1 . . . , 1], which represent the particular characteristics of the user's voice. Note that the user speaking the enrollment utterance 902 is not included in the set of training speakers, and the speech verification model generates a unique reference vector 904 for the user without retraining the neural network 700.

In general, the completion of an enrollment process causes the reference vector 904 to be stored at the client device in association with a user identity. For example, if the user identity corresponds to an owner or authorized user of the client device that stores the speaker verification model 900, the reference vector 904 can be designated to represent characteristics of an authorized user's voice. In some other implementations, the speaker verification model 900 may store the reference vector 904 at a server, a centralized database, or other device.

FIG. 10 is a flow diagram that illustrates an example process 1000 for enrolling a new speaker using the speaker verification model. The process 1000 may be performed by data processing apparatus, such as the client device 610 described above or another data processing apparatus.

The system obtains access to a neural network (1002). In some implementations, the system may obtain access to a neural network that has been trained to provide an orthogonal vector for each of the training utterances. For example, a speaker verification model may be, or may be derived from, a neural network that has been trained to provide a distinct 1×N feature vector for each speaker in a set of N training speakers. The feature vectors for the different training speakers may be orthogonal to each other. A client device may obtain access to the speaker verification model by communicating with a server system that trained the speaker verification model. In some implementations, the client device may store the speaker verification model locally for enrollment and verification processes.

The system inputs speech features corresponding to an utterance (1004). In some implementations, for each of multiple utterances of a particular speaker, the system may input speech data corresponding to the respective utterance to the neural network. For example, the system may prompt a user to speak multiple utterances. For each utterance, feature scores that indicate one or more audio characteristics of the utterance may be determined. The one or more audio characteristics of the training utterances may then be used as input to the neural network.

The system then obtains a reference vector (1006). In some implementations, for each of multiple utterances of the particular speaker, the system determines a vector for the respective utterance based on output of a hidden layer of the neural network, and the system combines the vectors for the respective utterances to obtain a reference vector of the particular speaker. In some implementations, the reference vector is an average of the vectors for the respective utterances.

FIG. 11 is a block diagram of an example speaker verification model 1100 for verifying the identity of an enrolled user. As discussed above, a neural network-based speaker verification method may be used for a small footprint text-dependent speaker verification task. As refers to in this Specification, a text-dependent speaker verification task refers to a computation task where a user speaks specific words or phrase that is predetermined. In other words, the input used for verification may be a predetermined word or phrase expected by the speaker verification model. The speaker verification model 1100 may be based on a neural network trained to classify training speakers with distinctive feature vectors. The trained neural network may be used to extract one or more speaker-specific feature vectors from one or more utterances. The speaker-specific feature vectors may be used for speaker verification, for example, to verify the identity of a previously enrolled speaker.

For example, the enrolled user may verify her identity by speaking the verification utterance 1102 to a client device. In some implementations, the client device may prompt the user to speak the verification utterance 1102 using predetermined text. The client device may record the verification utterance 1102. The client device may determine one or more feature scores that indicate one or more audio characteristics of the verification utterances 1102. The client device may input the one or more feature scores in the speaker verification model 910. The speaker verification model 910 generates an evaluation vector 1104. A comparator 1120 compares the evaluation vector 1104 to the reference vector 904 to verify the identity of the user. In some implementations, the comparator 1120 may generate a score indicating a likelihood that an utterance corresponds to an identity, and the identity may be accepted if the score satisfies a threshold. If the score does not satisfy the threshold, the identity may be rejected.

In some implementations, a cosine distance between the reference vector 904 and the evaluation vector 1104 may then be computed. A verification decision may be made by comparing the distance to a threshold. In some implementations, the comparator 1120 may be implemented on the client device 610. In some other implementations, the comparator 1120 may be implemented on the computing system 620. In some other implementations, the comparator 1120 may be implemented on another computing device or computing devices.

In some implementations, the client device may store multiple reference vectors, with each reference vector corresponding to a respective user. Each reference vector is a distinct vector generated by the speaker verification model. In some implementations, the comparator 1120 may compare the evaluation vector 1104 with multiple reference vectors stored at the client device. The client device may determine an identity of the speaker based on the output of the comparator 1120. For example, the client device may determine that the enrolled user corresponding to a reference vector that provides the shortest cosine distance to the evaluation vector 1104 to be the identity of the speaker, if the shortest cosine distance satisfies a threshold value.

In some implementations, a neural network-based technique and an vector-based technique can be used together to verify speaker identity. The reference vector system and the vector system can each generate a score indicating a likelihood that an utterance corresponds to an identity. The individual scores can be normalized, and the normalized scores may then be summed or otherwise combined to produce a combined score. A decision about the identity can then be made based on comparing the combined score to a threshold. In some instances, the combined use of an vector approach and a reference-vector approach may outperform either approach used individually.

In some implementations, a client device stores a different reference vector for each of multiple user identities. The client device may store data indicating which reference vector corresponds to each user identity. When a user attempts to access the client device, output of the speaker verification model may be compared with the reference vector corresponding to the user identity claimed by the speaker. In some implementations, the output of the speaker verification model may be compared with reference vectors of multiple different users, to identify which user identity is most likely to correspond to the speaker or to determine if any of the user identities correspond to the speaker.

FIG. 12 is a flow diagram that illustrates an example process 1200 for verifying the identity of an enrolled user using the speaker verification model. The process 1200 may be performed by data processing apparatus, such as the client device 610 described above or another data processing apparatus.

The system inputs speech data that correspond to a particular utterance to a neural network (1202). In some implementations, the neural network includes multiple hidden layers that are trained using utterances of multiple speakers, where the multiple speakers do not include the particular speaker.

The system determines an evaluation vector based on output at a hidden layer of the neural network (1204). In some implementations, the system determines an evaluation vector based on output at a last hidden layer of a trained neural network. In some other implementations, the system determines an evaluation vector based on output at a hidden layer of a trained neural network that optimizes the computation efficiency of a speaker verification model.

The system compares the evaluation vector with a reference vector that corresponds to a past utterance of a particular speaker (1206). In some implementations, the system compares the evaluation vector with the reference vector by determining a distance between the evaluation vector and the reference vector. For example, determining a distance between the evaluation vector and the reference vector may include computing a cosine distance between the evaluation vector and the reference vector.

The system verifies the identity of the particular speaker (1208). In some implementations, based on comparing the evaluation vector and the reference vector, the system determines whether the particular utterance was spoken by the particular speaker. In some implementations, the system determines whether the particular utterance was spoken by the particular speaker by determining whether the distance between the evaluation vector and the reference vector satisfies a threshold. In some implementations, the system determines an evaluation vector based on output at a hidden layer of the neural network by determining the evaluation vector based on activations at a last hidden layer of the neural network in response to inputting the speech data.

In some implementations, the neural network includes multiple hidden layers, and the system determines an evaluation vector based on output at a hidden layer of the neural network by determining the evaluation vector based on activations at a predetermined hidden layer of the multiple hidden layers in response to inputting the speech features.

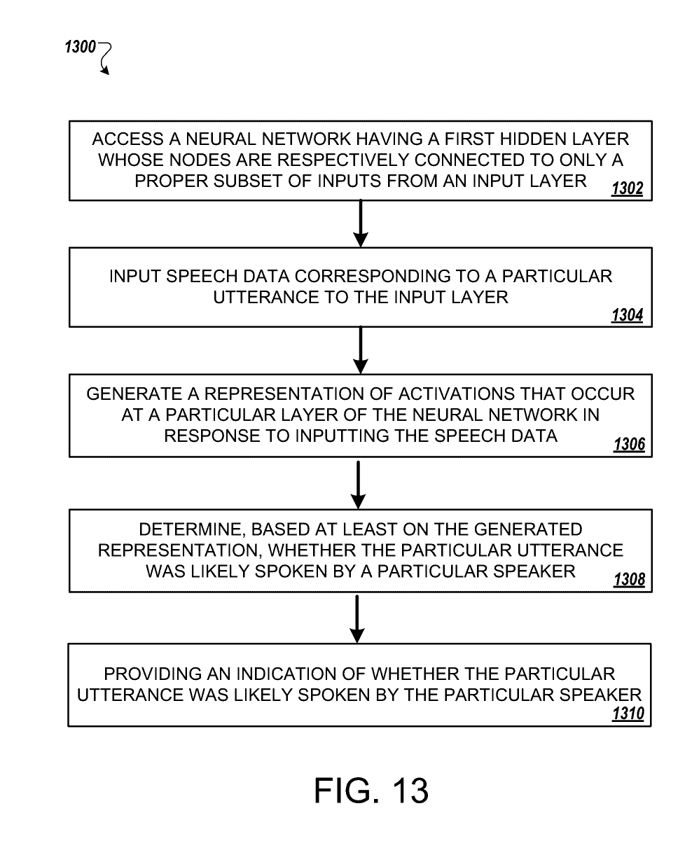

FIG. 13 is a flow diagram that illustrates an example process 1300 for verifying the identity of an enrolled user using a neural network. The following describes the process 1300 as being performed by components of systems that are described with reference to FIGS. 1A, 7A, 9, and 11. However, process 1300 may be performed by other systems or system configurations.

A neural network is accessed that has a first hidden layer whose nodes are respectively connected to only a proper subset of inputs from an input layer (1302). In some examples, a neural network that is stored at a user device is accessed by the user device. This may, for instance, correspond to client device 104 accessing neural network 120 that is both stored and run on client device 104. This may also correspond to accessing speaker verification model 910. In some examples, the neural network may be stored at a client device and occupy less than one megabyte of the client device's memory. In some examples, the neural network includes a quantity of stored weight values for each of the nodes of the hidden layer that is less than a quantity of inputs to the first hidden layer. Each node in the first hidden layer may, in some examples, be connected to between 5% and 50% of the inputs from the input layer. For example, each node may be connected to between 10% and 30% of the inputs from the input layer. As described in reference to Tables 1-3, the neural network may store fewer than 197,000 weight parameters. Particularly, the neural network may store fewer than 37,000 weight parameters for each of its layers.

Speech data corresponding to a particular utterance is input to the input layer of the neural network (1304). This may, for instance, correspond to recorded audio data 110 being provided to the input layer of the neural network 120 that is stored and run on client device 104. This may also correspond to verification utterance 1102 being provided to input layer 711 of speaker verification model 910.

A representation of activations that occur at a particular layer of the neural network in response to inputting the speech data is generated (1306). This may, for instance, correspond to generating a D-vector, such as representation 130 of activations 122 that occur at a particular layer of neural network 120. This may also correspond to evaluation vector 1104 being generated as a representation of activations that occur at last hidden layer 712k of speaker verification model 910. In some implementations, the speech data corresponding to the particular utterance is divided into frames. A corresponding set of activations occurring at the particular layer of the neural network may, for instance, be determined for each of multiple different frames of the speech data. In these implementations, a representation of activations that occur at the particular layer of the neural network in response to inputting the speech data is generated by averaging the sets of activations that respectively correspond to the multiple different frames.

A determination of whether the particular utterance was likely spoken by a particular speaker is made based at least on the generated representation (1308). This may, for instance, correspond to one or more determinations performed by speaker identifier module 130. This may also correspond to one or more determinations performed by comparator 1120. The neural network may, in some examples, be a trained neural network that was not, however, trained using speech of the particular speaker. In some implementations, the neural network has been trained based on activations occurring at an output layer located downstream from the particular layer of the neural network. For instance, neural network 120 or speaker verification model 910 may have been trained based on activations occurring at an output layer, such as output layer 713, located downstream from the particular layer of the neural network, such as last hidden layer 712k.

An indication of whether the particular utterance was likely spoken by the particular speaker is provided (1310). This may, for instance, correspond to providing result 132 or another indication, such as screen 134.

In some examples, the particular utterance may be detected at a mobile device. In these examples, the indication provided may be that which is provided in association with or as part of the mobile device being unlocked or woken up from a low power state in response to it being determined that the particular utterance was likely spoken by the particular speaker, the user of the mobile device being authenticated in response to it being determined that the particular utterance was likely spoken by the particular speaker, the user of the mobile device being provided with access to one or more applications and/or websites in response to it being determined that the particular utterance was likely spoken by the particular speaker, a virtual assistant being invoked at the mobile device in response to it being determined that the particular utterance was likely spoken by the particular speaker, preferences or user interface customizations being applied on the mobile device in response to it being determined that the particular utterance was likely spoken by the particular speaker, a voice command be performed at the mobile device in response to it being determined that the particular utterance was likely spoken by the particular speaker, authentication data being sent from the mobile device to one or more other computing devices over a network in response to it being determined that the particular utterance was likely spoken by the particular speaker, or a combination thereof. The mobile device at which the particular utterance is detected may, in some or all of these examples, store the neural network.

In some implementations, the first hidden layer of the neural network is a locally-connected layer. Such a locally-connected layer may be configured such that nodes at the first hidden layer respectively receive input from different subsets of data from the input layer. In other implementations, the first hidden layer of the neural network is a convolutional layer. Such a convolutional layer may include at least a group of nodes that are associated with a same set of weight values. The neural network may apply the same set of weight values to different subsets of the input for different nodes in the group of nodes of the convolutional layer.

In some examples, each of the nodes of the first hidden layer may receive input from a localized region of the inputs from the input layer. The proper subset of the input to which each node of the first hidden layer is connected may, in some examples, be localized in time and/or frequency. In some examples, the inputs provided by the input layer indicate characteristics of the utterance at a first range of frequencies during each time frame in a first range of time. Each of at least some of the nodes in the first hidden layer may only be connected to inputs from the input layer that indicate characteristics of the utterance for a second range of frequencies during each time frame in a second range of time. In these examples, the second range of frequencies may be a proper subset of the first range of frequencies and the second range of time may be a proper subset of the first range of time.

In some implementations, the input at the input layer comprises data for a set of multiple frames that represents characteristics of the particular utterance during a range of time, and each of the nodes is only connected to inputs for a proper subset of the multiple frames. Frames may, in some examples, be adjacent in time. In some examples, each input at the input layer includes at least some data for all frames within a given range of time and excludes all frames outside the range of time. In such examples, the given range of time may be less than the full range of times represented at the input. In some instances, the set of multiple frames which correspond to the input at the input layer may include a particular frame and context before and/or after the particular frame. In the example of FIG. 1B, this context window may, for instance, include 35 frames before the particular frame and 12 frames after the particular frame. These frames are referred to herein as left and right context frames. In the example of FIG. 5, this context window may, for instance, include 30 frames to the left and 10 frames to the right. It is to be understood that other types and sizes of context windows may be utilized with the techniques described herein.

In some implementations, the input at the input layer comprises data for multiple frequencies, and each of the nodes is only connected to inputs for a proper subset of the frequencies. In some examples, each input at the input layer includes some data for each of the features representing frequencies within a given range of frequencies and excludes inputs for features corresponding to frequencies that are outside the frequency range. In such examples, the given range of frequencies may be less than the full range indicated by the inputs. Each of the nodes of the first input layer may, in some instances, be connected to inputs corresponding to particular range of frequency input features. Such features may include Mel-frequency cepstral coefficients (MFCCs) and/or other log filterbank parameters.

In some examples, a cosine distance between the generated representation and a reference representation corresponding to the particular speaker is determined and compared to a threshold. In such examples, it may be determined that the particular utterance was likely spoken by a particular speaker may be made based on it being determined that the cosine distance satisfies the threshold to which it was compared.

In some implementations, the generated representation is compared with a reference representation of activations occurring at the particular layer of the neural network in response to speech data that corresponds to a past utterance of the particular speaker. In these implementations, the determination of whether the particular utterance was likely spoken by the particular speaker may be performed based on the comparison of the generated representation and the reference representation.

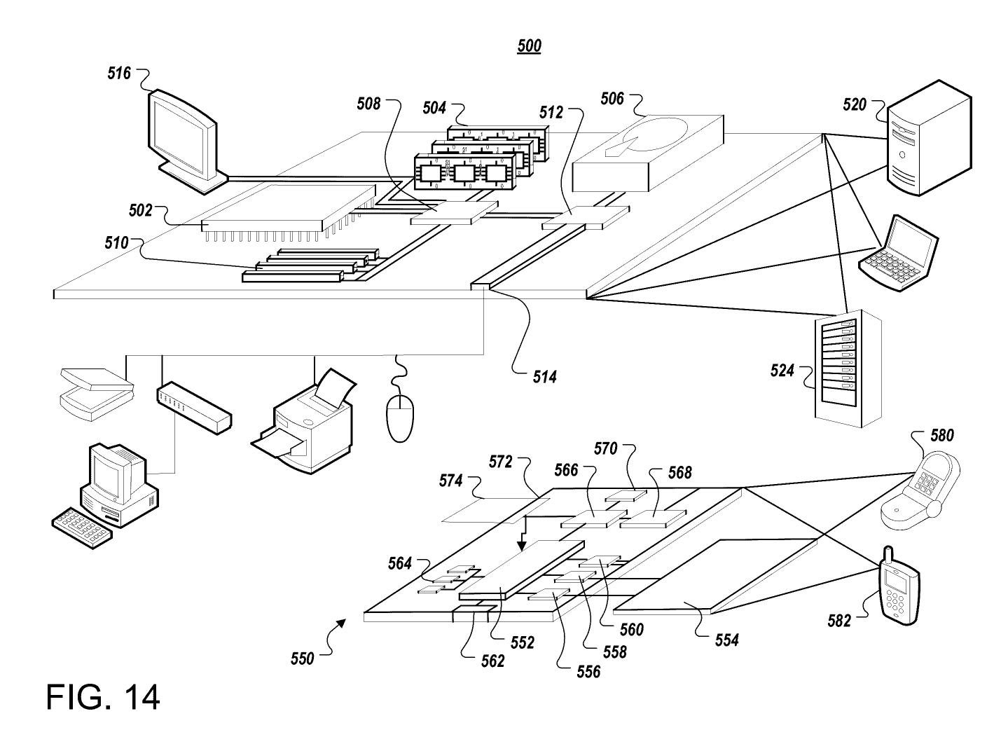

FIG. 14 shows an example of a computing device 1400 and a mobile computing device 1450 that can be used to implement the techniques described here. The computing device 1400 is intended to represent various forms of digital computers, such as laptops, desktops, workstations, personal digital assistants, servers, blade servers, mainframes, and other appropriate computers. The mobile computing device 1450 is intended to represent various forms of mobile devices, such as personal digital assistants, cellular telephones, smart-phones, and other similar computing devices. The components shown here, their connections and relationships, and their functions, are meant to be examples only, and are not meant to be limiting.

The computing device 1400 includes a processor 1402, a memory 1404, a storage device 1406, a high-speed interface 1408 connecting to the memory 1404 and multiple high-speed expansion ports 1410, and a low-speed interface 1412 connecting to a low-speed expansion port 1414 and the storage device 1406. Each of the processor 1402, the memory 1404, the storage device 1406, the high-speed interface 1408, the high-speed expansion ports 1410, and the low-speed interface 1412, are interconnected using various busses, and may be mounted on a common motherboard or in other manners as appropriate. The processor 1402 can process instructions for execution within the computing device 1400, including instructions stored in the memory 1404 or on the storage device 1406 to display graphical information for a graphical user interface (GUI) on an external input/output device, such as a display 1416 coupled to the high-speed interface 1408. In other implementations, multiple processors and/or multiple buses may be used, as appropriate, along with multiple memories and types of memory. Also, multiple computing devices may be connected, with each device providing portions of the necessary operations, e.g., as a server bank, a group of blade servers, or a multi-processor system.

The memory 1404 stores information within the computing device 1400. In some implementations, the memory 1404 is a volatile memory unit or units. In some implementations, the memory 1404 is a non-volatile memory unit or units. The memory 1404 may also be another form of computer-readable medium, such as a magnetic or optical disk.

The storage device 1406 is capable of providing mass storage for the computing device 1400. In some implementations, the storage device 1406 may be or contain a computer-readable medium, such as a floppy disk device, a hard disk device, an optical disk device, or a tape device, a flash memory or other similar solid state memory device, or an array of devices, including devices in a storage area network or other configurations. Instructions can be stored in an information carrier. The instructions, when executed by one or more processing devices, for example, processor 1402, perform one or more methods, such as those described above. The instructions can also be stored by one or more storage devices such as computer- or machine-readable mediums, for example, the memory 1404, the storage device 1406, or memory on the processor 1402.

The high-speed interface 1408 manages bandwidth-intensive operations for the computing device 1400, while the low-speed interface 1412 manages lower bandwidth-intensive operations. Such allocation of functions is an example only. In some implementations, the high-speed interface 1408 is coupled to the memory 1404, the display 1416, e.g., through a graphics processor or accelerator, and to the high-speed expansion ports 1410, which may accept various expansion cards (not shown). In the implementation, the low-speed interface 1412 is coupled to the storage device 1406 and the low-speed expansion port 1414. The low-speed expansion port 1414, which may include various communication ports, e.g., USB, Bluetooth, Ethernet, wireless Ethernet, may be coupled to one or more input/output devices, such as a keyboard, a pointing device, a scanner, or a networking device such as a switch or router, e.g., through a network adapter.

The computing device 1400 may be implemented in a number of different forms, as shown in the figure. For example, it may be implemented as a standard server 1420, or multiple times in a group of such servers. In addition, it may be implemented in a personal computer such as a laptop computer 1422. It may also be implemented as part of a rack server system 1424. Alternatively, components from the computing device 1400 may be combined with other components in a mobile device (not shown), such as a mobile computing device 1450. Each of such devices may contain one or more of the computing device 1400 and the mobile computing device 1450, and an entire system may be made up of multiple computing devices communicating with each other.

The mobile computing device 1450 includes a processor 1452, a memory 1464, an input/output device such as a display 1454, a communication interface 1466, and a transceiver 1468, among other components. The mobile computing device 1450 may also be provided with a storage device, such as a micro-drive or other device, to provide additional storage. Each of the processor 1452, the memory 1464, the display 1454, the communication interface 1466, and the transceiver 1468, are interconnected using various buses, and several of the components may be mounted on a common motherboard or in other manners as appropriate.

The processor 1452 can execute instructions within the mobile computing device 1450, including instructions stored in the memory 1464. The processor 1452 may be implemented as a chipset of chips that include separate and multiple analog and digital processors. The processor 1452 may provide, for example, for coordination of the other components of the mobile computing device 1450, such as control of user interfaces, applications run by the mobile computing device 1450, and wireless communication by the mobile computing device 1450.

The processor 1452 may communicate with a user through a control interface 1458 and a display interface 1456 coupled to the display 1454. The display 1454 may be, for example, a TFT (Thin-Film-Transistor Liquid Crystal Display) display or an OLED (Organic Light Emitting Diode) display, or other appropriate display technology. The display interface 1456 may comprise appropriate circuitry for driving the display 1454 to present graphical and other information to a user. The control interface 1458 may receive commands from a user and convert them for submission to the processor 1452. In addition, an external interface 1462 may provide communication with the processor 1452, so as to enable near area communication of the mobile computing device 1450 with other devices. The external interface 1462 may provide, for example, for wired communication in some implementations, or for wireless communication in other implementations, and multiple interfaces may also be used.

The memory 1464 stores information within the mobile computing device 1450. The memory 1464 can be implemented as one or more of a computer-readable medium or media, a volatile memory unit or units, or a non-volatile memory unit or units. An expansion memory 1474 may also be provided and connected to the mobile computing device 1450 through an expansion interface 1472, which may include, for example, a SIMM (Single In Line Memory Module) card interface. The expansion memory 1474 may provide extra storage space for the mobile computing device 1450, or may also store applications or other information for the mobile computing device 1450. Specifically, the expansion memory 1474 may include instructions to carry out or supplement the processes described above, and may include secure information also. Thus, for example, the expansion memory 1474 may be provided as a security module for the mobile computing device 1450, and may be programmed with instructions that permit secure use of the mobile computing device 1450. In addition, secure applications may be provided via the SIMM cards, along with additional information, such as placing identifying information on the SIMM card in a non-hackable manner.

The memory may include, for example, flash memory and/or NVRAM memory (non-volatile random access memory), as discussed below. In some implementations, instructions are stored in an information carrier that the instructions, when executed by one or more processing devices, for example, processor 1452, perform one or more methods, such as those described above. The instructions can also be stored by one or more storage devices, such as one or more computer- or machine-readable mediums, for example, the memory 1464, the expansion memory 1474, or memory on the processor 1452. In some implementations, the instructions can be received in a propagated signal, for example, over the transceiver 1468 or the external interface 1462.

The mobile computing device 1450 may communicate wirelessly through the communication interface 1466, which may include digital signal processing circuitry where necessary. The communication interface 1466 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication may occur, for example, through the transceiver 1468 using a radio-frequency. In addition, short-range communication may occur, such as using a Bluetooth, WiFi, or other such transceiver (not shown). In addition, a GPS (Global Positioning System) receiver module 1470 may provide additional navigation- and location-related wireless data to the mobile computing device 1450, which may be used as appropriate by applications running on the mobile computing device 1450.

The mobile computing device 1450 may also communicate audibly using an audio codec 1460, which may receive spoken information from a user and convert it to usable digital information. The audio codec 1460 may likewise generate audible sound for a user, such as through a speaker, e.g., in a handset of the mobile computing device 1450. Such sound may include sound from voice telephone calls, may include recorded sound, e.g., voice messages, music files, etc., and may also include sound generated by applications operating on the mobile computing device 1450.

The mobile computing device 1450 may be implemented in a number of different forms, as shown in the figure. For example, it may be implemented as a cellular telephone 1480. It may also be implemented as part of a smart-phone 1482, personal digital assistant, or other similar mobile device.

Embodiments of the subject matter, the functional operations and the processes described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible nonvolatile program carrier for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “data processing apparatus” encompasses all kinds of apparatus, devices, and machines for processing data, including by way of example a programmable processor, a computer, or multiple processors or computers. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a standalone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Computers suitable for the execution of a computer program include, by way of example, can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are contemplated. For example, the actions discussed can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other steps may be provided, or steps may be eliminated, from the described processes. Accordingly, other implementations are within the scope of the claims.

1. A computer-implemented method comprising:
accessing a neural network having an input layer and one or more hidden layers, wherein at least one hidden layer of the one or more hidden layers has nodes that are respectively connected to only a proper subset of the inputs from a previous layer that provides input to the at least one hidden layer;
inputting, to the input layer of the neural network, speech data that corresponds to a particular utterance;
generating a representation of activations that occur, in response to inputting the speech data that corresponds to the particular utterance to the input layer, at a particular layer of the neural network that was configured as a hidden layer during training of the neural network;
determining, based at least on the generated representation, whether the particular utterance was likely spoken by a particular speaker; and
providing an indication of whether the particular utterance was likely spoken by the particular speaker.

2. The method of claim 1, wherein the at least one hidden layer is a locally-connected layer configured such that nodes at the at least one hidden layer respectively receive input from different subsets of data from the previous layer.

3. The method of claim 1, wherein each of the nodes of the at least one hidden layer receives input from a localized region of the outputs of the previous layer.

4. The method of claim 3, wherein each of the nodes of the at least one hidden layer receives input from a proper subset of the outputs of the previous layer that is localized in time.

5. The method of claim 3, wherein each of the nodes of the at least one hidden layer receives input from a proper subset of the outputs of the previous layer that is localized in frequency.

6. The method of claim 1, wherein each of the nodes of the at least one hidden layer receives input from a respective subset of inputs from the previous layer, the respective subset being localized in time and in frequency.

7. The method of claim 6, wherein the inputs provided by the previous layer indicate characteristics of the utterance at a first range of frequencies during each time frame in a first range of time;
wherein for each of at least some of the nodes of the at least one hidden layer, the node is only connected to inputs from the previous layer that indicate characteristics of the utterance for a second range of frequencies during each time frame in a second range of time, wherein the second range of frequencies is a proper subset of the first range of frequencies and the second range of time is a proper subset of the first range of time.

8. The method of claim 1, wherein the previous layer provides a number of inputs to the at least one hidden layer;
wherein, for each of the nodes of the at least one hidden layer, the neural network comprises a number of stored weight values that is less than the number of inputs to the at least one hidden layer.

9. The method of claim 1, wherein the at least one hidden layer is a convolutional layer.

10. The method of claim 9, wherein at least a group of the nodes of the at least one hidden layer are associated with a same set of weight values, wherein the neural network applies the same set of weight values to different subsets of the input for different nodes in the group.

11. The method of claim 1, comprising:
comparing the generated representation with a reference representation of activations occurring at the particular layer of the neural network in response to speech data that corresponds to a past utterance of the particular speaker; and
wherein determining whether the particular utterance was likely spoken by the particular speaker based at least on the generated representation comprises:
based on comparing the generated representation and the reference representation, determining whether the particular utterance was likely spoken by the particular speaker.

12. The method of claim 1, wherein determining whether the particular utterance was likely spoken by the particular speaker based at least on the generated representation comprises:
determining a cosine distance between the generated representation and a reference representation corresponding to the particular speaker;
determining that the cosine distance satisfies a threshold; and
based on determining that the cosine distance satisfies the threshold, determining that the particular utterance was likely spoken by the particular speaker.

13. The method of claim 1, further comprising dividing the speech data corresponding to the particular utterance into frames; and
wherein generating the representation of activations occurring at the particular layer of the neural network comprises:
determining, for each of multiple different frames of the speech data, a corresponding set of activations occurring at the particular layer of the neural network; and
generating the representation of the activations occurring at the particular layer by averaging the sets of activations that respectively correspond to the multiple different frames.

14. The method of claim 1, wherein accessing the neural network comprises accessing a trained neural network that is not trained using speech of the particular speaker.

15. The method of claim 14, wherein accessing the neural network comprises:
accessing a neural network having nodes at the first hidden layer that are each connected to a different subset of the inputs from the input layer, wherein the neural network has been trained based on activations occurring at an output layer located downstream from the particular layer.

16. The method of claim 1, wherein accessing the neural network comprises accessing, by a user device, a neural network stored at the user device.

17. The method of claim 1, comprising detecting the particular utterance at a mobile device that stores the neural network;
wherein determining whether the particular utterance was likely spoken by the particular speaker comprises determining that the particular utterance was likely spoken by the particular speaker; and
wherein providing an indication of whether the particular utterance was likely spoken by the particular speaker comprises unlocking or waking up the mobile device in response to determining that the particular utterance was likely spoken by the particular speaker.

18. The method of claim 1, wherein each node of the at least one hidden layer is connected to between 5% and 50% of the inputs from the previous layer.

19. A computer program product, encoded on one or more non-transitory computer storage media, comprising instructions that when executed by one or more computers cause the one or more computers to perform operations comprising:
accessing a neural network having an input layer and one or more hidden layers, wherein at least one hidden layer of the one or more hidden layers has nodes that are respectively connected to only a proper subset of the inputs from a previous layer that provides input to the at least one hidden layer;
inputting, to the input layer of the neural network, speech data that corresponds to a particular utterance;
generating a representation of activations that occur, in response to inputting the speech data that corresponds to the particular utterance to the input layer, at a particular layer of the neural network that was configured as a hidden layer during training of the neural network;
determining, based at least on the generated representation, whether the particular utterance was likely spoken by a particular speaker; and
providing an indication of whether the particular utterance was likely spoken by the particular speaker.

20. A system comprising:
one or more computers and one or more storage devices storing instructions that are operable, when executed by the one or more computers, to cause the one or more computers to perform operations comprising:
accessing a neural network having an input layer and one or more hidden layers, wherein at least one hidden layer of the one or more hidden layers has nodes that are respectively connected to only a proper subset of the inputs from a previous layer that provides input to the at least one hidden layer;
inputting, to the input layer of the neural network, speech data that corresponds to a particular utterance;
generating a representation of activations that occur, in response to inputting the speech data that corresponds to the particular utterance to the input layer, at a particular layer of the neural network that was configured as a hidden layer during training of the neural network;
determining, based at least on the generated representation, whether the particular utterance was likely spoken by a particular speaker; and
providing an indication of whether the particular utterance was likely spoken by the particular speaker.
